(19) United States
(12) Patent Application Publication
(10) Pub. No.: US 2026/0151861 A1
(43) Pub. Date: Jun. 4, 2026

(54) STAINLESS STEEL AND COPPER JOINED BODY, METHOD OF PRODUCING SAME, AND METHOD OF JOINING STAINLESS STEEL AND COPPER

(71) Applicant: JFE STEEL CORPORATION, Chiyoda-ku, Tokyo (JP)

(72) Inventor: Shuji NISHIDA, Chiyoda-ku, Tokyo (JP)

(73) Assignee: JFE STEEL CORPORATION, Chiyoda-ku, Tokyo (JP)

(21) Appl. No.: 19/130,116

(22) PCT Filed: Aug. 2, 2023
(86) PCT No.: PCT/JP2023/028336

§ 371 Date: May 15, 2025

(30) Foreign Application Priority Data
Dec. 2, 2022 (JP) 2022-193743

(51) Int. Cl. B23K 35/24; B23K 103/04; B23K 103/12; B32B 7/05; B32B 15/01; B32B 15/20

(52) U.S. Cl. CPC B23K 35/24; B32B 7/05; B32B 15/013; B32B 15/20; B23K 2103/04; B23K 2103/12; B32B 2250/02; B32B 2311/12; B32B 2311/30

(57) ABSTRACT

Provided is a stainless steel and copper joined body that has high reliability, as an alternative to silver brazing. A welded portion is formed at an overlapping portion where stainless steel and copper overlap each other, the welded portion includes a plurality of welding points on the copper side surface of the joined body in the welding direction, the Cu/Fe ratio of the welded portion is 10.0 or more, the relationship of the following Expression (1) is satisfied for MF and t, and the relationship of the following Expression (2) is satisfied for MF and B. MF≥0.8t . . . (1), 0.10MF≤B≤1.25MF . . . (2).

### TECHNICAL FIELD

The present disclosure relates to a stainless steel and copper joined body, a method of producing same, and a method of joining stainless steel and copper.

### BACKGROUND

Stainless steel is a material that has excellent corrosion resistance and is widely used in various heat exchangers for automobiles and air conditioners as steel sheets and steel pipes or tubes. Further, copper is a material that has excellent thermal conductivity and is widely used in various heat exchangers as copper sheets and copper pipes or tubes.

In recent years, with the rising price of copper, there has been a trend to change the material of copper heat exchangers from copper to stainless steel. However, changing all materials from copper to stainless steel is difficult, and some copper components will remain. In such a case, a product is produced by combining stainless steel and copper components, and therefore stainless steel and copper must be joined.

### CITATION LIST

### Patent Literature

PTL 1: JP 2003-523830 A
PTL 2: JP 2005-349443 A

### SUMMARY

### Technical Problem

Brazing is commonly used in the production of heat exchangers as a method for joining components. Brazing may be broadly classified into furnace brazing, in which members are heated in an atmospheric furnace for multiple-point simultaneous joining, and torch brazing, in which a joined portion is heated in air with a torch for single-point joining. Both methods may be used at different stages of product assembly.

Of these, particularly in torch brazing, materials to be joined are exposed to high temperatures in the air. Therefore, when a material to be joined is stainless steel, a firm and dense oxide coating that hinders brazing tends to form on the surface of the stainless steel. Accordingly, in torch brazing stainless steel components to copper components, performing brazing at low temperatures is necessary.

In view of the above, silver filler having a low melting point (melting point: about 600° C. to 700° C.) is commonly used for joining stainless steel and copper. However, silver filler is expensive. Further, appropriate torch brazing requires skill in operation. Further, an oxide coating may form on the surface of stainless steel that hinders brazing even at about 600° C. Therefore, the use of flux is necessary for joining stainless steel and copper. However, the use of flux may reduce the corrosion resistance of stainless steel and copper. Further, cleaning to remove flux is labor intensive and leads to a reduction in productivity.

As such, there is a need to develop an alternative method of joining stainless steel and copper to replace torch brazing using silver filler (hereinafter also referred to as silver brazing).

As an example method of joining stainless steel and copper as an alternative to silver brazing, Patent Literature (PTL) 1 describes:

“a method for making a joint between copper or copper alloys and austenitic steel alloys, in which method in between the junction surfaces of the objects to be joined together, there is arranged at least one intermediate layer, so that the junction surfaces including their intermediate layers are pressed together, and at least the junction area is heated in order to create a diffusion joint, characterized in that there is brought a first intermediate layer (3) on the junction surface of the steel object (2) or against said surface, mainly in order to prevent the nickel loss from the steel object (2), and at least a second intermediate layer (4) on the junction surface of the copper object (1) or against said surface in order to activate the creation of a diffusion joint.”

Further, PTL 2 describes:

“a method of joining stainless steel and an object to be joined to the stainless steel, comprising: bringing a joining agent comprising solder and a joining metal into contact between the stainless steel and the object to be joined; and performing heat treatment while the joining agent is in contact with the stainless steel and the object to be joined.”

Here, the technique described in PTL 1 provides an intermediate layer such as Ni between the joining surfaces of stainless steel and copper. Further, the technique described in PTL 2 provides solder and a joining metal between the joining surfaces of stainless steel and copper. However, in products such as heat exchangers, contact with liquid and condensation occurs during use. Therefore, when stainless steel and copper joined bodies obtained by the techniques described in PTL 1 and 2 are applied to such products, there is a strong concern about contact corrosion of dissimilar metals due to a potential difference between the intermediate layer, solder, joint metal, copper, and stainless steel.

Thus, in joining stainless steel and copper, a highly reliable joining method as an alternative to silver brazing has not been established, and the development of such a joining method is currently desired.

The present disclosure was developed in view of the situation described above, as it would be helpful to provide a highly reliable method of joining stainless steel and copper as an alternative to silver brazing, as well as a stainless steel and copper joined body and a method of producing same.

### Solution to Problem

In order to achieve the above, the inventors conducted extensive studies and came to the conclusion that use of welding is desirable as a highly reliable joining method as an alternative to silver brazing. However, welding stainless steel to copper has conventionally been considered difficult. One factor is cracking of the welded portion. The inventors studied the factors that cause this cracking of the welded portion and made the following discoveries.

In welding stainless steel and copper, when the stainless steel and copper melt and mix, the liquid phase separates into two phases: a first liquid phase that is mainly a stainless steel component and a second liquid phase that is mainly a copper component. The greater the amount of stainless steel melted relative to copper, the greater the proportion of the first liquid phase.

The solidification microstructure formed by cooling of the first liquid phase is brittle. Further, during the cooling process after welding, internal stress is generated in the joined portion due to a difference in thermal shrinkage rate between the stainless steel base metal and the copper base metal. When the amount of the first liquid phase described above is large, the internal stress described above causes the solidification microstructure of the first liquid phase to fracture. That is, the internal stress leads to cracking of the welded portion. The internal stress tends to be particularly concentrated at welding start portions and end portions. Therefore, cracks in the welded portion are particularly likely to form at welding start portions and end portions. Further, cracks that occur often propagate and penetrate through the welded portion.

Based on the above discoveries, the inventors studied and focused on a difference in melting points between stainless steel and copper. That is, the melting point of stainless steel is about 1400° C. to 1500° C. In contrast, the melting point of copper is about 1100° C. Therefore, the inventors considered the following method. In addition to joint type being a lap joint, an electrode is positioned on the copper side of the overlapping portion of the material to be joined, stainless steel and copper, to actively melt only the copper. The molten copper being brought into contact with the surface of the stainless steel and allowed to solidify increases the proportion of copper in the fusion zone. That is, the inventors studied suppression of formation of the first liquid phase mainly composed of a stainless steel component, in order to avoid cracking of the welded portion. Here, a lap joint is a joint where the welded portion (welding position) is located at an overlapping portion where the stainless steel and the copper overlap each other in the joined body (or material to be joined). The welded portion being located in the overlapping portion means that the entire welded portion is located in the overlapping portion. That is, as illustrated in FIG. 3, in a perpendicular-to-welding direction, the copper end of the overlapping portion is a reference position, 0, the copper side is +ve, the stainless steel side is −ve, and the entire welded portion is in a range from 0 to +L. Here, L is the width of the overlapping portion in the perpendicular-to-welding direction (mm). Preferably, the welded portion is located in the overlapping portion and spaced apart from the copper end and the stainless steel end in the perpendicular-to-welding direction.

However, even when only copper is melted under typical welding conditions, heat from the molten copper may be transferred to the stainless steel, causing much of the stainless steel to melt as well. Therefore, it was found that under typical welding conditions, actively melting only copper is difficult.

In view of the above, the inventors considered adopting a welding method that allows precise control of heat input conditions, particularly TIG welding.

However, it was found that even when welding is performed while actively melting only copper, or in other words, suppressing the melting of stainless steel, sufficient joined portion strength (hereinafter also referred to as joint strength) and airtightness might not be obtained. That is, continuous heat input, as in typical TIG welding, raises the temperature of the stainless steel and forms a firm oxide coating on the surface of the stainless steel, even when the melting of the stainless steel is suppressed. It was found that molten copper is sometimes repelled by this oxide coating, preventing the copper from spreading across the surface of the stainless steel, resulting in insufficient joint strength and airtightness.

Therefore, the inventors further investigated methods to suppress oxide coating formation on the stainless steel surface during welding while actively melting only copper. As a result, the inventors made the following discoveries.

In detail, TIG welding is used as the welding method, and an electrode is positioned on the copper side of material to be joined. Further, dividing the heat input associated with welding into a plurality of localized and short-duration heat inputs is effective. In particular, it is effective to divide the heat input into a plurality of heat inputs so that the following conditions (a) through (e) are satisfied and the relationship of Expression (4) is satisfied. This can suppress oxide coating formation on the stainless steel surface during welding by suppressing the melting of the stainless steel and the temperature increase of the stainless steel while actively melting only the copper.
(a) inclination angle of electrode α is 0° to 45°
   Here, the thickness direction of the material to be joined is a reference angle, 0°, and the angle between the direction in which the tip of the electrode faces and the thickness direction of the material to be joined is the inclination angle of the electrode.
(b) electrode height is more than 0 mm and 3.0 mm or less
(c) each heat input position in the perpendicular-to-welding direction, in mm, is 0.5×0.03×I×d^{0.5}/t^{0.5} or more and L−0.5×0.03×I×d^{0.5}/t^{0.5} or less
   Here, I is welding current in A, d is welding time in s, t is copper thickness in mm, and L is width of the overlapping portion where the stainless steel and the copper overlap each other. Further, each heat input position in the perpendicular-to-welding direction is set with the copper end of the overlapping portion as the reference position, 0, with the copper side as +ve and the stainless steel side as −ve.
(d) distance interval in the welding direction between each heat input point, in mm, is 0.1×{Dₖ₋₁×(1−0.2×t)} or more and Dₖ₋₁×(1−0.2×t) or less
   Here, Dₖ₋₁ is the diameter, in mm, of a welding point formed by the immediately preceding heat input on the copper side surface of the material to be joined. t is the copper thickness, in mm.
(e) time interval between each heat input is 100% or more of the welding time, in s, of the immediately preceding heat input

$${t}^{1.5} / ( 1 - 0.2 \times t ) \div 0.03 \leq I \times {d}^{0.5} \leq {t}^{1.5} / ( 1 - 0.2 \times t ) \div 0.03 \times 6 \qquad ( 4 )$$

Here,
I is welding current in A,
d is welding time in s, and
t is copper thickness t, in mm.

Further, the inventors also discovered that dividing the heat input for welding into a plurality of localized, short-duration heat inputs as described above also suppresses cracking in the welded portion.

That is, cracking in the welded portion is caused by internal stress in the joined portion due to the difference in thermal shrinkage rate between the stainless steel base metal and the copper base metal during the cooling process after welding. In particular, this internal stress (in other words, restraint stress) tends to be higher in a lap joint than in a joint geometry such as a lap fillet joint. In this regard, by dividing the heat input associated with welding into a plurality of localized and short-duration heat inputs, internal stress can be distributed and decreased. Further, by dividing the heat input associated with welding into a plurality of localized and short-duration heat inputs, excessive melting of the stainless steel is suppressed. As a result, dissolution of stainless steel into the fusion zone, and thus the formation of the first liquid phase described above, can be suppressed. The synergy of these effects sufficiently suppresses cracking of the welded portion.

Even when the heat input associated with welding is divided up, when the heat input points are excessively close to each other or when the time interval between heat inputs is excessively short, heat input to the stainless steel becomes excessive. This may cause excessive melting of the stainless steel and cracking of the welded portion. From the viewpoint of preventing cracking of the welded portion and also from the viewpoint of suppressing oxide coating formation on the stainless steel surface during welding, it is important to appropriately control (d) the distance interval in the welding direction of each heat input and (e) the time interval of each heat input as described above, in addition to the heat input amount itself.

Further, based on the above discoveries, the inventors further investigated and found that a stainless steel and copper joined body that has sufficient joint strength and airtightness and does not have cracking in the welded portion is obtainable by simultaneously satisfying the following points.
The welded portion is located at the overlapping portion where the stainless steel and the copper overlap each other, that is, a lap joint. At the same time, the welded portion comprises a plurality of welding points that are continuous in the welding direction on the copper side surface of the joined body.
The Cu/Fe ratio of the welded portion is 10.0 or more.
The relationship of the following Expression (1) is satisfied for MF and t. Further, the relationship of the following Expression (2) is satisfied for MF and B.

$$MF \geq 0.8 t \qquad ( 1 )$$

$$0.1 MF \leq B \leq 1.25 MF \qquad ( 2 )$$

Here,
MF is distance, in mm, along the interface between the stainless steel and the copper of the joined body in the perpendicular-to-welding direction, between fusion boundaries between the welded portion and the copper,
B is average distance interval, in mm, of welding points on the copper side surface of the joined body, and
t is copper thickness, in mm.

The present disclosure is based on these discoveries and further studies.

Primary features of the present disclosure are as follows.

1. A stainless steel and copper joined body, comprising stainless steel, copper, and a welded portion of the stainless steel and the copper, wherein
the stainless steel and the copper each have a sheet or tubular shape,
the welded portion is located at an overlapping portion where the stainless steel and the copper overlap each other, and the welded portion has a plurality of welding points that are continuous in the welding direction on the copper side surface of the joined body,
a Cu/Fe ratio of the welded portion is 10.0 or more,
MF and t satisfy the relationship in the following Expression (1),
MF and B satisfy the relationship in the following Expression (2),

$$MF \geq 0.8 t \qquad ( 1 )$$

$$0.1 MF \leq B \leq 1.25 MF \qquad ( 2 )$$

where
MF is distance, in mm, along the interface between the stainless steel and the copper of the joined body in the perpendicular-to-welding direction, between fusion boundaries between the welded portion and the copper,
B is average distance interval, in mm, of welding points on the copper side surface of the joined body, and
t is copper thickness, in mm.

2. The stainless steel and copper joined body according to 1, above, wherein Dₘₐₓ/Dₘᵢₙ satisfies the relationship in the following Expression (3),

$${D}_{max} / {D}_{min} \leq 1.4 \qquad ( 3 )$$

where
Dₘᵢₙ is minimum diameter, in mm, of the welding points on the copper side surface of the joined body, and
Dₘₐₓ is maximum diameter, in mm, of the welding points on the copper side surface of the joined body.

3. A method of joining stainless steel and copper, wherein overlapping stainless steel and copper material to be joined is joined by welding,
the welding is TIG welding,
the TIG welding comprises
   positioning an electrode at the copper side of the material to be joined, and performing a plurality of heat inputs under conditions satisfying (a) to (e) below:
      (a) inclination angle of electrode α is 0° to 45°,
         where a thickness direction of the material to be joined is a reference angle, 0°, and the angle between the direction in which the tip of the electrode faces and the thickness direction of the material to be joined is the inclination angle of the electrode;
      (b) electrode height is more than 0 mm and 3.0 mm or less;
      (c) each heat input position in the perpendicular-to-welding direction, in mm, is 0.5×0.03×I×d^{0.5}/t^{0.5} or more and L−0.5×0.03×I×d^{0.5}/t^{0.5} or less,
         where I is welding current in A, d is welding time in s, tis copper thickness in mm, and Lis width of the overlapping portion where the stainless steel and the copper overlap each other, and further, each heat input position in the perpendicular-to-welding direction is set with a copper end of the overlapping portion as a reference position, 0, with the copper side as +ve and the stainless steel side as −ve;
      (d) distance interval in the welding direction between each heat input point, in mm, is 0.1×{Dₖ₋₁×(1−0.2×t)} or more and Dₖ₋₁×(1−0.2×t) or less,
         where Dₖ₋₁ is the diameter, in mm, of a welding point formed by the immediately preceding heat input on the copper side surface of the material to be joined, and t is the copper thickness, in mm; and
      (e) time interval between each heat input is 100% or more of the welding time, in s, of the immediately preceding heat input,
   and further, the relationship in the following Expression (4) is satisfied at each heat input,

$${t}^{1.5} / ( 1 - 0.2 \times t ) \div 0.03 \leq I \times {d}^{0.5} \leq {t}^{1.5} / ( 1 - 0.2 \times t ) \div 0.03 \times 6 \qquad ( 4 )$$

where
I is welding current in A,
d is welding time in s, and
t is copper thickness t, in mm.

4. The method of joining stainless steel and copper according to 3, above, wherein at least one of conditions (f) to (h) below is satisfied:
(f) for each heat input, the welding current of the heat input is the welding current of the immediately preceding heat input or less;
(g) for each heat input, the welding time of the heat input is the welding time of the immediately preceding heat input or less; or
(h) a long heat input time interval is provided between some heat inputs,

excluding a case where the welding current, the welding time, and the time interval between heat inputs are constant for each heat input.

5. A method of producing a stainless steel and copper joined body by joining stainless steel and copper by the method of joining stainless steel and copper according to 3 or 4, above.

### Advantageous Effect

According to the present disclosure, as an alternative to silver brazing, a highly reliable (in other words, resulting in sufficient joint strength, sufficient airtightness, and no cracking of the welded portion) method of joining stainless steel and copper and a stainless steel and copper joined body are provided. Further, the stainless steel and copper joined body may be produced at a significantly lower cost than when using silver brazing, which is extremely advantageous when applied to various equipment such as heat exchangers, for example, where stainless steel and copper are joined.

### BRIEF DESCRIPTION OF THE DRAWINGS

In the accompanying drawings:

FIG. 1 is an example of an optical micrograph of a cross-section (Y-Z plane) perpendicular to the welding direction at a welded portion of a stainless steel and copper joined body according to an embodiment of the present disclosure;

FIG. 2 is an example of an external photograph of a welded portion of a stainless steel and copper joined body according to an embodiment of the present disclosure, illustrating the joined body photographed from the copper side in the thickness direction;

FIG. 3 is a schematic diagram illustrating an example of spatial arrangement of material to be joined in a method of joining stainless steel and copper according to an embodiment of the present disclosure; and

FIG. 4 is a schematic diagram illustrating an example of spatial arrangement of an electrode in a method of joining stainless steel and copper according to an embodiment of the present disclosure.

### DETAILED DESCRIPTION

The following describes embodiments of the present disclosure.

### [1] Stainless Steel and Copper Joined Body

A stainless steel and copper joined body according to an embodiment of the present disclosure is
a stainless steel and copper joined body, comprising stainless steel, copper, and a welded portion of the stainless steel and the copper, wherein
the stainless steel and the copper each have a sheet or tubular shape,
the welded portion is located at an overlapping portion where the stainless steel and the copper overlap each other, and the welded portion has a plurality of welding points that are continuous in the welding direction on the copper side surface of the joined body,
a Cu/Fe ratio of the welded portion is 10.0 or more,
MF and t satisfy the relationship in Expression (1), and
MF and B satisfy the relationship in Expression (2).

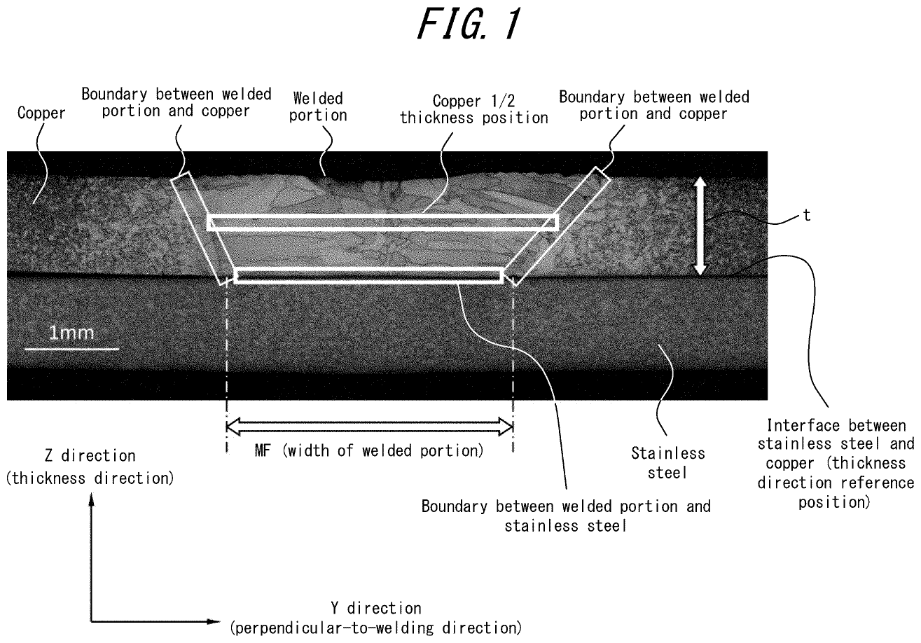

In FIG. 1 to FIG. 4, X direction, Y direction, and Z direction are defined as follows.

X direction is the welding direction (may also be used to refer to a copper edge direction along the interface between stainless steel and copper, and a longitudinal direction of the welded portion).

Y direction is the perpendicular-to-welding direction (perpendicular to the welding direction and perpendicular to a thickness direction (Z direction) as described below).

Z direction is the thickness direction of the joined body or the material to be joined (the interface between stainless steel and copper is the reference position, 0, with the copper side being +ve and the stainless steel side being −ve. May also refer to a direction perpendicular to the interface between stainless steel and copper. Hereinafter, also referred to simply as the thickness direction).

FIG. 1 is an example of an optical micrograph of a cross-section (Y-Z plane) perpendicular to the welding direction at the welded portion of a stainless steel and copper joined body according to an embodiment of the present disclosure.

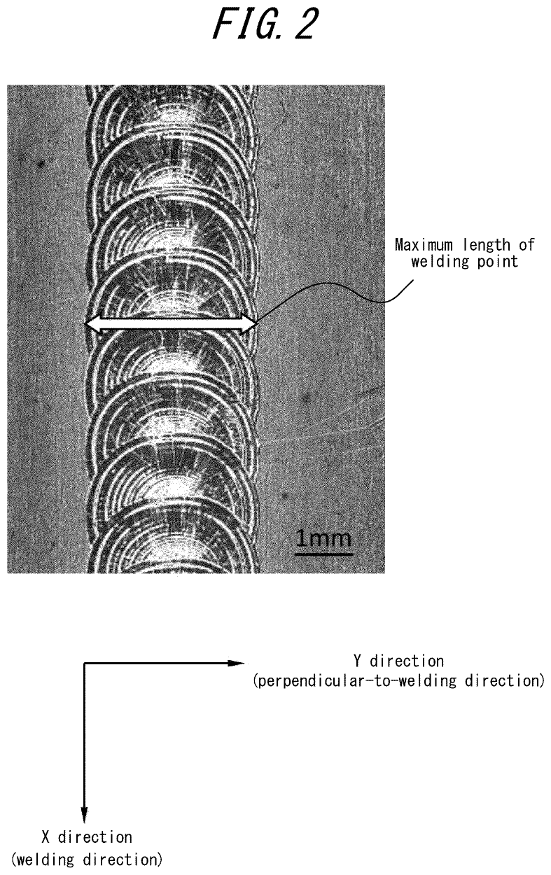

FIG. 2 is an example of an external photograph of a welded portion of a stainless steel and copper joined body according to an embodiment of the present disclosure, illustrating the joined body photographed from the copper side in the thickness direction.

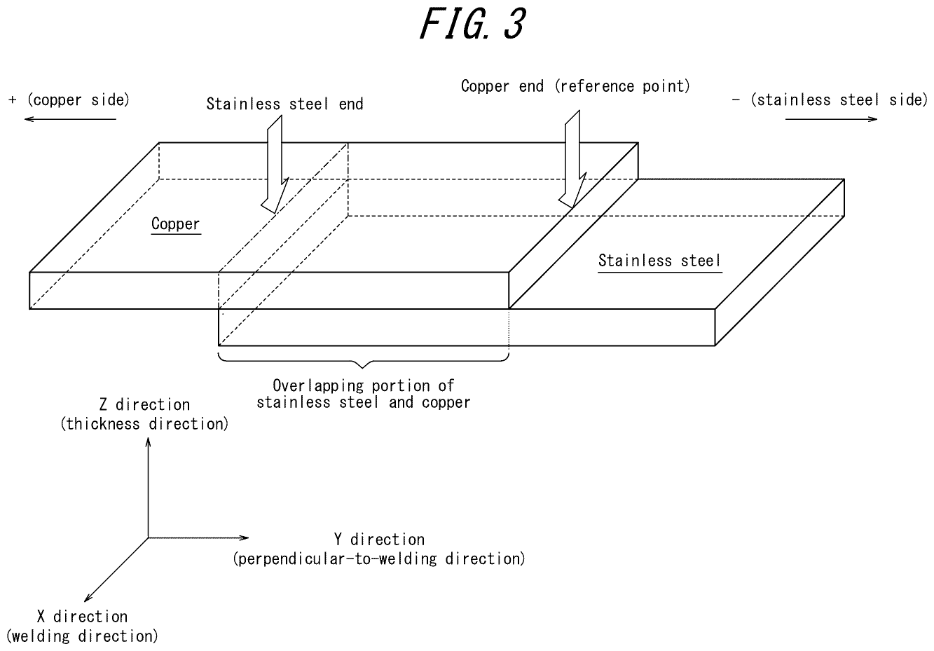

FIG. 3 is a schematic diagram illustrating an example of spatial arrangement of material to be joined in a method of joining stainless steel and copper according to an embodiment of the present disclosure.

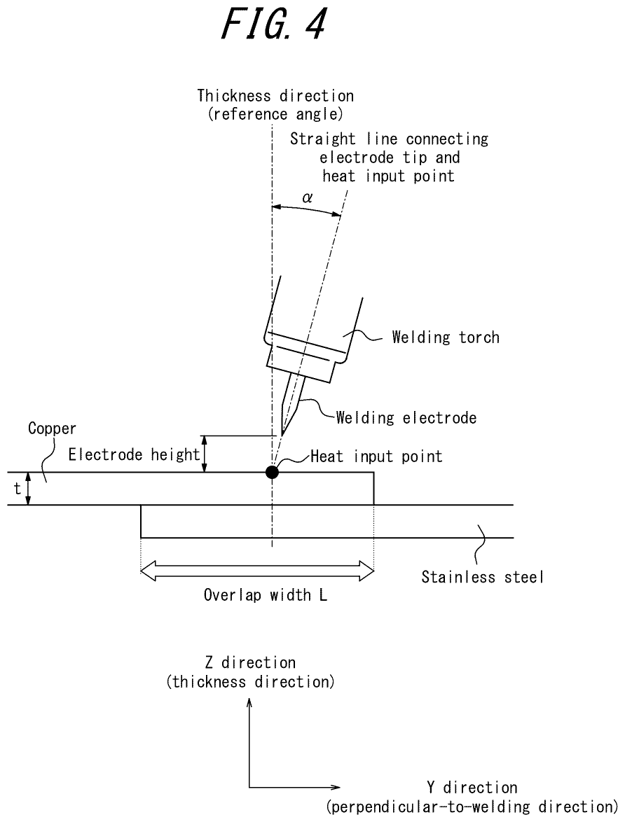

FIG. 4 is a schematic diagram illustrating an example of spatial arrangement of an electrode in a method of joining stainless steel and copper according to an embodiment of the present disclosure.

### (1) Stainless Steel

A base metal is stainless steel, which may be in the shape of a sheet (stainless steel sheet) or a tube (stainless steel pipe or tube). The sheet shape here includes curved sheets (bent sheets) as well as flat sheets. The stainless steel thickness (sheet thickness or tube thickness) is not particularly limited. From the viewpoint of joinability, the stainless steel thickness is preferably 0.1 mm or more. Further, the stainless steel thickness is preferably 4.0 mm or less. The stainless steel thickness is more preferably 0.2 mm or more. The stainless steel thickness is even more preferably 0.3 mm or more. The stainless steel thickness is more preferably 2.0 mm or less. The stainless steel thickness is even more preferably 1.0 mm or less.

When the stainless steel used as the base metal is in the shape of a sheet, the size of the sheet is not particularly limited. For example, from the viewpoint of heat transfer and dissipation during welding, a length in the direction perpendicular to the welding direction is preferably 10 mm or more. The length in the direction perpendicular to the welding direction is more preferably 30 mm or more.

When the base metal stainless steel is tubular in shape, the size of the tube (outer diameter and length) is not particularly limited. For example, from the viewpoint of heat transfer and dissipation during welding, the outer diameter of the tube is preferably four times the tube thickness (wall thickness) or more. The length of the tube is preferably 10 mm or more. The length of the tube is more preferably 30 mm or more.

Further, the chemical composition of the stainless steel is not particularly limited and typical stainless steel composition suffices. For example, an iron-based alloy containing 10.5 mass % Cr or more and 50 mass % Fe or more. Examples include austenitic stainless steel sheets, austenitic-ferritic stainless steel sheets, ferritic stainless steel sheets, martensitic stainless steel sheets, precipitate-hardened stainless steel sheets, and processed products thereof, as defined in Japanese Industrial Standard JIS G 4305:2021. Further examples include stainless steel sanitary pipes, stainless steel tubes for ordinary piping, stainless steel pipes for piping, stainless steel tubes for boilers and heat exchangers, and processed products thereof, as defined in JIS G 3447:2015, JIS G 3448:2016, JIS G 3459:2021, JIS G 3463:2019, and JIS G 3468:2021. Stainless steel sheets that have various surface finishes may be used, such as No. 2B finish (annealed and pickled skin pass finish), No. 2D finish (annealed and pickled finish), No. 4 finish (polished finish), No. 8 finish (mirror polished finish), BA finish (bright annealed finish), HL (hairline) finish, dull finish, embossing finish, and blast finish.

### (2) Copper

A base metal is copper, which may be in the shape of a sheet (copper sheet) or a tube (copper pipe or tube). The sheet shape here includes curved sheets (bent sheets) as well as flat sheets. The copper thickness (sheet thickness or tube thickness) is not particularly limited. From the viewpoint of joinability, the copper thickness is preferably 0.1 mm or more. Further, the copper thickness is preferably 4.0 mm or less. The copper thickness is more preferably 0.3 mm or more. The copper thickness is even more preferably 0.5 mm or more. Further, the copper thickness is more preferably 2.0 mm or less. The copper thickness is even more preferably 1.0 mm or less.

When the copper used as the base metal is in the shape of a sheet, the size of the sheet is not particularly limited. For example, from the viewpoint of heat transfer and dissipation during welding, a length in the direction perpendicular to the welding direction is preferably 10 mm or more. The length in the direction perpendicular to the welding direction is more preferably 30 mm or more.

When the base metal copper is tubular in shape, the size of the tube (outer diameter and length) is not particularly limited. For example, from the viewpoint of heat transfer and dissipation during welding, the outer diameter of the tube is preferably four times the tube thickness (wall thickness) or more. The length of the tube is preferably 10 mm or more. The length of the tube is more preferably 30 mm or more.

Copper here includes not only so-called pure copper consisting of Cu and inevitable impurity, but also copper alloys containing 50 mass % Cu or more. Examples include various copper sheets and tubes, including oxygen-free copper, tough-pitch copper, and phosphorous-deoxidized copper, as well as processed products thereof, as defined in JIS H 3100:2018. Further examples include copper seamless tubes and welded tubes, and processed products thereof, as defined in JIS H 3300:2018 and JIS H 3320:2006. Copper sheets that have various surface finishes may be used, including HL (hairline) finish, satin finish, blast finish, and hammered finish.

### (3) Welded Portion

In the stainless steel and copper joined body according to an embodiment of the present disclosure, the base metals, stainless steel and copper, are joined by a welded portion, as illustrated in FIG. 1. Further, the welded portion is located at the overlapping portion where the stainless steel and the copper overlap each other. That is, as described above, the entire welded portion is located in the overlapping portion. Preferably, the welded portion is located in the overlapping portion and spaced apart from the copper end and the stainless steel end in the perpendicular-to-welding direction. Here, the welded portion does not include the heat-affected zone.

The welded portion is defined, for example, as follows. Observation by SEM is performed on a cross-section sample as illustrated in FIG. 1, prepared in the manner described below, at a magnification of 100×. The interface between the welded portion and the stainless steel (base metal), the interface between the welded portion and the copper (base metal) (hereinafter also referred to as the fusion boundary), and the welded portion are determined from the cross-section shape, contrast difference of each microstructure, interface contrast, crystal grain size, and crystal grain anisotropy (aspect ratio) observed in a reflected electron image.

For example, copper and stainless steel (as base metals) have parallel top and bottom surfaces in cross-section, and crystal grains are isotropic. In contrast, the welded portion has top and bottom surfaces that are not parallel in cross-section, and crystal grains are long and narrow and highly anisotropic. Further, for example, at the interface between the copper and the welded portion is an area of contrast change (hereinafter also referred to as a fusion line). Further, the interface between the stainless steel and the welded portion is often different in contrast to the surrounding area, or there is a fusion line as described above. Further, as illustrated in FIG. 2, the welded portion comprises a plurality of welding points that are continuous in the welding direction on the copper side surface of the joined body. The number of welding points is not particularly limited as long as the number is 2 or more. The number of welding points is preferably 5 or more. In particular, the number of welding points is preferably 8 to 16 per 10 mm in the welding direction. Further, “continuous in the welding direction” means that a portion of each welding point overlaps with an adjacent welding point in the welding direction on the surface of the welded portion, as illustrated in FIG. 2.

Further, when the welded portion is viewed from the copper side along the thickness direction, the entire weld bead is located between the copper end and the stainless steel end in the perpendicular-to-welding direction. That is, the welded portion here differs from a lap fillet welded portion in that the copper end remains unmelted.

Whether or not the welded portion described above is located at the overlapping portion of the material to be joined is determined, for example, as follows. First, the joined body is observed from the stainless steel side surface of the joined body to check the stainless steel end. When it is difficult to check the stainless steel end from the stainless steel side surface due to the structure of the joined body, such as in the case of a pipe, the stainless steel end can be checked by destructive testing, such as cutting the joined body and observing the cross-section, or by non-destructive testing, such as X-ray testing. The joined body is then observed from the copper side surface of the joined body to check the copper end. Further, the stainless steel end is projected onto the copper side surface of the joined body and transcribed. When the entire welded portion (weld bead), which is checked by observing the joined body from the copper side surface of the joined body, is located between the copper end and the stainless steel end (the transcribed portion described above) in the perpendicular-to-welding direction, then the welded portion is judged to be located in the overlapping portion.

In the stainless steel and copper joined body according to an embodiment of the present disclosure, it is particularly important to properly control the Cu/Fe ratio of the welded portion and the size and arrangement of the welding points of the welded portion.

### Cu/Fe Ratio of Welded Portion: 10.0 or More

The welded portion of a lap weld, where the welded portion is located at the overlapping portion, tends to have higher restraint stress than the welded portion of a butting weld, a lap fillet weld, or the like. Here, restraint stress means the internal stress in the joined portion caused by the difference in thermal shrinkage rate between the stainless steel base metal and the copper base metal during the cooling process after welding. Further, this restraint stress is one factor that can lead to cracking of the welded portion. In such a lap weld, the Cu/Fe ratio of the welded portion needs to be sufficiently high to suppress cracking of the welded portion. The high Cu/Fe ratio of the welded portion means that the formation of the first liquid phase described above is decreased during welding. The decreased formation of the first liquid phase effectively suppresses cracking of the welded portion.

When the Cu/Fe ratio of the welded portion is less than 10.0, a large amount of the first liquid phase mainly composed of a stainless steel component is generated, leading to cracking of the welded portion. The Cu/Fe ratio of the welded portion is therefore 10.0 or more. The Cu/Fe ratio of the welded portion is preferably 20.0 or more. An upper limit of the Cu/Fe ratio of the welded portion is not particularly limited. The Cu/Fe ratio of the welded portion is preferably, for example, 100.0 or less.

Here, the Cu/Fe ratio of the welded portion is measured at a copper 1/2 thickness position. For example, the Cu/Fe ratio of the welded portion is calculated as follows. First, a cross-section sample in the thickness direction of the welded portion (a sample with a cross-section in the plane perpendicular to the X direction that is the welding direction (Y-Z plane)), as illustrated in FIG. 1, is prepared with a mirror polish finish. The cross-section sample is then etched using picric acid hydrochloric acid (100 mL ethanol-1 g picric acid-5 mL hydrochloric acid). Next, the cross-section sample is observed by SEM at a magnification of 100×, and then analyzed by SEM-EDS. In this analysis, an EDS point scan is performed on the welded portion of the cross-section, that is, the solidification microstructure portion. The two elements to be analyzed are Fe and Cu. The Cu/Fe ratio is then measured from the mass fractions (mass %) of these two elements using the following Expression (5). The EDS scan points are 10 randomly selected points at the copper 1/2 thickness position (the 1/2t position with the interface between the stainless steel and the copper as the reference position (0)). The Cu/Fe ratios measured at the points are then averaged to obtain the Cu/Fe ratio of one cross-section sample. This measurement is performed on five cross-section samples taken at random from the welded portion, and the average Cu/Fe ratio of the cross-section samples obtained is considered to be the Cu/Fe ratio of the welded portion.

$$Cu / Fe ratio = Cu / Fe \qquad ( 5 )$$

Here, Cu and Fe on the right side of the Expression mean the mass fractions of Cu and Fe (mass %), respectively, as determined by the EDS point scans.

$$MF \geq 0.8 t \qquad ( 1 )$$

As illustrated in FIG. 1, in the cross-section perpendicular to the welding direction of the joined body (Y-Z plane), the welded portion is located between the fusion boundaries between the copper and the welded portion (fusion line). It is essential that the relationship of Expression (1) be satisfied with respect to the distance MF, in mm, between the fusion boundaries between the welded portion and the copper (hereinafter also simply referred to as distance MF, or MF), relative to the copper thickness t, in mm (hereinafter also simply referred to as t). The distance MF is the distance along the interface between the stainless steel and the copper at the back face of the copper in the perpendicular-to-welding direction.

Here, when MF is less than 0.8t, the heat input transferred to the stainless steel during welding is insufficient, resulting in insufficient joining of the stainless steel and the copper. As a result, sufficient joint strength is unobtainable. MF is therefore 0.8t or more. MF is preferably 1.6t or more. An upper limit of MF is not particularly limited. From the viewpoint of preventing strain of copper, MF is preferably, for example, 6.0t or less. Further, MF is preferably 0.3×L or less. Here, L is the width (length in the perpendicular-to-welding direction) of the overlapping portion where the stainless steel and the copper overlap each other in the joined body. Lis substantially the same as the width of the overlapping portion where the stainless steel and the copper overlap each other in the material to be joined, as described below.

Here, MF is measured as follows.

Observation by SEM is performed on a cross-section sample as illustrated in FIG. 1, prepared in the manner described above, at a magnification of 100×. The welded portion is then defined by determining the fusion boundaries between the welded portion and the copper using the procedure described above. At the interface between the stainless steel and the copper, that is, the reference position (0) in the thickness direction, the width in the perpendicular-to-welding direction of the welded portion (the distance between the two fusion boundaries illustrated in FIG. 1 at the reference position (0) in the thickness direction) is measured to obtain MF for one cross-section sample. This measurement is performed on each cross-section sample prepared by cutting the target joined body into eight equal sections in the welding direction, and the average value of MF for the cross-section samples obtained is taken as MF.

$$0.1 MF \leq B \leq 1.25 MF \qquad ( 2 )$$

When the average distance interval B, in mm, of welding points on the copper side surface of the joined body (hereinafter also simply referred to as average distance interval B, or B) is less than 0.10MF, the number of heat inputs to the same location increases, effectively resulting in excessive heat input to the same location. Accordingly, formation of an oxide coating on the surface of the stainless steel is insufficiently suppressed, and sufficient joint strength becomes unobtainable. Further, formation of the first liquid phase mainly composed of a stainless steel component may be increased, leading to cracking of the welded portion.

On the other hand, when B exceeds 1.25MF, then even when the welding points are continuous on the surface of the welded portion, the stainless steel and copper joining is discontinuous on the back face of the copper, which is the interface between the stainless steel and the copper. As a result, sufficient airtightness is unobtainable.

B is therefore from 0.10MF to 1.25MF. B is preferably 0.20MF or more. B is preferably 1.00MF or less.

Here, B is calculated by the following Expression (6).

$$B = A / n \qquad ( 6 )$$

Here, A is the length of the welded portion in the welding direction. n is the number of welding points. A may be measured using calipers, for example.

Depending on the shape, A may be determined, for example, as (D₁+Dₙ)/2+ (B₂+B₃+ . . . . Bₙ). Here, D₁ and Dₙ are the diameters of the 1st and nth welding points, respectively. Further, Bk is the shortest center-to-center distance (mm) between a kth welding point and a (k−1)th welding point formed immediately before it.

For example, when the joined body is a stainless steel pipe or tube and a copper pipe or tube (the stainless steel and the copper are tubular) and the welding points go around once, that is, the first and last welding points are adjacent (overlapping), A is the length of the entire circumference in the welding direction of the welded portion. In this case, A may be determined, for example, as B₁+B₂+B₃+ . . . . Bₙ. B₁ is the shortest center-to-center distance (mm) between the 1st and nth welding points.

Further, in the stainless steel and copper joined body according to an embodiment of the present disclosure, the structure described above helps prevents cracking of the welded portion and helps prevent join discontinuity at the interface between the stainless steel and the copper, and therefore good airtightness, preferably 0.2 MPa or more, is obtainable.

Here, airtightness is measured as follows, for example.

### In the Case of a Joined Body of a Stainless Steel Sheet and a Copper Sheet (the Stainless Steel and the Copper are in the Shape of a Sheet)

A test piece for evaluating airtightness is cut out so that the length in the welding direction is 20 mm from the center of the welded portion on the surface of the joined body (the side where the welded portion is located). Next, pipe repair putty or the like (hereinafter also referred to as putty) is placed on the end in the welding direction of the overlapping portion of the stainless steel and the copper of the test piece. Next, a circle that has a radius of 10 mm (diameter of 20 mm) is drawn around the center of the copper end of the test piece in the welding direction (hereinafter also referred to as the reference circle), and putty is placed on the reference circle in a doughnut shape. Next, a tube end of a copper tube that has an outer diameter of 20 mm and a wall thickness of 1 mm (the end face is a plane perpendicular to the copper tube longitudinal direction) is placed inside the putty placed in the doughnut shape and pressed perpendicular to the joined body. Further, putty is additionally applied to seal any gap between the copper tube and the joined body in order to prevent air leakage from any gap between the copper tube and the joined body when air is fed into the copper tube as described below. A regulator and a compressor are then connected to the other end of the copper tube, and airtightness is measured in the same manner as for the case of a tube, described below. When the joined body is too small to draw the reference circle of the above size on the surface of the joined body, one end of the copper tube may be sealed by attaching an auxiliary plate to the joined body or by other means.

### In the Case of a Joined Body of a Stainless Steel Pipe or Tube and a Copper Pipe or Tube (the Stainless Steel and the Copper are Tubular)

One tube end of the joined body is sealed with pipe repair putty or the like and the regulator and the compressor are connected to the other end. Then, under an air environment, the joined body is immersed in water at a depth of 20 cm and air is pumped into the inside of the joined body to set the inside of the joined body to a defined pressure (for example, 0.2 MPa). In the case of the depth of the water varying depending on the position of the welded portion due to the welded portion not forming a flat surface or for other reasons, it suffices that the entire welded portion is immersed in the water and the deepest point is 20 cm below the surface of the water. The airtightness of the joined body is considered to be the defined pressure or more when no air bubbles are generated from the joined body before 10 minutes have elapsed after the inside of the joined body has reached the defined pressure.

In addition, in a stainless steel and copper joined body according to an embodiment of the present disclosure, the joint strength is preferably 60% or more of the strength (tensile strength) of the lower strength of the base metals, stainless steel and copper. The joint strength is more preferably 80% or more of the lower strength of the base metals.

In particular, by setting the Cu/Fe ratio of the welded portion to 20.0 or more and MF to 1.6t or more, greater joint strength can be obtained, specifically joint strength that is 80% or more of the strength of the lower strength of the base metals, stainless steel and copper. The reason for this to be is considered to be as follows. By setting the Cu/Fe ratio of the welded portion to 20.0 or more, the formation of oxide coating on the surface of the stainless steel is more effectively suppressed and the amount of the first liquid phase, which is mainly composed of stainless steel, is decreased. Further, the area of the copper and stainless steel joining interface is increased by setting MF to 1.6t or more. As a result, higher joint strength is obtained.

Here, joint strength is measured according to JIS Z 2241:2011. However, each tensile test piece is taken from a joined body so that the joined portion (welded portion) is a parallel portion of the test piece and the longitudinal direction (tensile direction) of the test piece is the perpendicular-to-welding direction. The maximum test force obtained from the tensile test is divided by the parallel portion width of the test piece to calculate the maximum test force per unit width (unit length in the longitudinal direction of the welded portion). The calculated maximum test force per unit width is then used as the joint strength. Spacers are attached to the grip portions of the tensile test pieces taken from the joined bodies (stainless steel grip portion and copper grip portion) prior to the tensile test so that the tensile axis is parallel to the stainless steel and the copper. Further, the overlapping portion of the stainless steel and the copper is not used as a grip portion.

Further, the strength of the base metals, stainless steel and copper, is measured as follows, for example. Tensile test pieces are taken from a base metal portion of the stainless steel and a base metal portion of the copper in the vicinity the joined portion of the joined body, respectively, so that the longitudinal direction of each test piece coincides with the longitudinal direction (perpendicular-to-welding direction) of the test piece used in the joint strength measurement described above. Then, a tensile test is performed in the same manner as in the measurement of joint strength, and the maximum test force obtained from the tensile test is divided by the parallel portion width of the test piece to calculate the maximum test force per unit width. The maximum test force per unit width of each test piece is then used as the strength of stainless steel or copper, respectively.

The test piece shapes may be determined arbitrarily according to the shape of the joined body, as long as the width of the parallel portion is 1 mm or more and the length of the parallel portion is 5 mm or more.

A stainless steel and copper joined body according to an embodiment of the present disclosure may be either a sheet (including bent sheets (curved sheets) in addition to flat sheets) or tubular, as long as a portion of each material overlaps and includes the welded portion. When tubular, the joined body is a stainless steel pipe or tube and a copper pipe or tube. For example, in any of the following combinations, the joined body may be a portion of the stainless steel pipe or tube inserted into the copper pipe or tube and joined: a combination where the outside diameter of a stainless steel pipe or tube is approximately equal to the inside diameter of a copper pipe or tube, a combination of a stainless steel pipe or tube and a copper pipe or tube with an end expanded to be approximately equal to the outside diameter of the stainless steel pipe or tube, a combination of a copper pipe or tube and a stainless steel pipe or tube with an end reduced to be approximately equal to the inside diameter of the copper pipe or tube, and the like. Further, a stainless steel and copper joined body according to an embodiment of the present disclosure includes a joined body including a plurality of joined portions, at least one of which is the welded portion described above.

$${D}_{max} / {D}_{min} \leq 1.4$$

When Dₘₐₓ/Dₘᵢₙ, the ratio of the maximum diameter Dₘₐₓ (mm) to the minimum diameter Dₘᵢₙ (mm) at welding points on the copper side surface of the joined body (hereinafter also referred to as bead width change ratio), is 1.4 or less, excellent appearance with little bead width change is obtainable. Dₘₐₓ/Dₘᵢₙ is therefore preferably 1.4 or less. Dₘₐₓ/Dₘᵢₙ is more preferably 1.2 or less. A lower limit of Dₘₐₓ/Dₘᵢₙ is not particularly limited. For example, Dₘₐₓ/Dₘᵢₙ may be 1.0 or more.

Dₘᵢₙ and Dₘₐₓ are the minimum and maximum values, respectively, of the welding point diameter Dₖ (k=1 to n).

Here, the welding point diameter, Dₖ, is calculated as follows, for example. As illustrated in FIG. 2, on the copper side surface of the joined body, the welding points of the welded portion of the joined body are observed using a 10× loupe from the direction perpendicular to the observation plane, in other words from the copper side in the thickness direction. For each welding point, the maximum length Lk in the perpendicular-to-welding direction is then measured. For each welding point, Lk is taken as the diameter Dₖ of the welding point. A caliper may be used to measure the maximum length of each welding point. As illustrated in FIG. 2, the above measurement method is used because the outlines of welding points are partially lost due to subsequently formed welding points. Here, k is an integer from 1 to n indicating each welding point (each heat input), and n is the number of welding points (heat input count).

### [2] Method of Joining Stainless Steel and Copper

A method of joining stainless steel and copper according to an embodiment of the present disclosure is
a method of joining stainless steel and copper, wherein overlapping stainless steel and copper material to be joined is joined by welding,
the welding is TIG welding,
the TIG welding comprises
   positioning an electrode at the copper side of the material to be joined, and performing a plurality of heat inputs under conditions satisfying (a) to (e) below:
      (a) inclination angle of electrode α is 0° to 45°,
         where a thickness direction of the material to be joined is a reference angle, 0°, and the angle between the direction in which the tip of the electrode faces and the thickness direction of the material to be joined is the inclination angle of the electrode;
      (b) electrode height is more than 0 mm and 3.0 mm or less;
      (c) each heat input position in the perpendicular-to-welding direction, in mm, is 0.5×0.03×I×d^{0.5}/t^{0.5} or more and L−0.5×0.03×I×d^{0.5}/t^{0.5} or less,
         where I is welding current in A, d is welding time in s, tis copper thickness in mm, and L is width of the overlapping portion where the stainless steel and the copper overlap each other, and further, each heat input position in the perpendicular-to-welding direction is set with a copper end of the overlapping portion as a reference position, 0, with the copper side as +ve and the stainless steel side as −ve;
      (d) distance interval in the welding direction between each heat input point, in mm, is 0.1×{Dₖ₋₁×(1−0.2×t)} or more and Dₖ₋₁×(1−0.2×t) or less,
         where Dₖ₋₁ is the diameter, in mm, of a welding point formed by the immediately preceding heat input on the copper side surface of the material to be joined, and t is the copper thickness, in mm; and
      (e) time interval between each heat input is 100% or more of the welding time, in s, of the immediately preceding heat input,
   and further, the relationship in Expression (4) is satisfied at each heat input.

The method of joining stainless steel and copper according to an embodiment of the present disclosure is described below, with reference to the schematic diagram illustrating an example of the spatial arrangement of the material to be joined in FIG. 3 and the schematic diagram illustrating an example of the spatial arrangement of the electrode in FIG. 4.

In the method of joining stainless steel and copper according to an embodiment of the present disclosure, the overlapping stainless steel and copper material to be joined is joined by welding, as illustrated in FIG. 3. For example, in the case of sheet shapes, a copper sheet is preferably disposed overlapping and vertically above a stainless steel sheet. In the case of tubular shapes, overlapping such that a stainless steel pipe or tube is inside and a copper pipe or tube is outside is preferable (for example, a portion of a stainless steel pipe or tube is inserted into a copper pipe or tube). Although not particularly limited, the width of the overlapping portion of the stainless steel and the copper (width in the perpendicular-to-welding direction) is preferably 5 mm to 20 mm. A gap thickness at the overlapping portion between the stainless steel and the copper is not particularly limited. The gap thickness is preferably 1/2 the copper thickness or less. Preferred thicknesses, shapes, chemical composition, and the like of the stainless steel and the copper are as described under [1].

### Welding Method: TIG Welding

In the method of joining stainless steel and copper according to an embodiment of the present disclosure, the conditions of heat input need to be precisely controlled in order to suppress melting of the stainless steel and actively melt only the copper. Therefore, the welding method employed in the lap weld is TIG welding.

### Electrode Position: Copper Side of Material to be Joined

In the method of joining stainless steel and copper according to an embodiment of the present disclosure, the copper is melted and solidified on the stainless steel at each heat input by TIG welding, thereby joining the stainless steel and the copper. For this purpose, the heat input points are on the copper side of the overlapping portion of the material to be joined, as illustrated in FIG. 4, so that heat input may be preferentially applied to the copper. That is, the electrode is positioned on the copper side of the material to be joined.

Further, in the method of joining stainless steel and copper according to an embodiment of the present disclosure, it is important to divide the heat inputs associated with welding into a plurality of localized and short-duration heat inputs and to satisfy the following conditions (a) to (e). The heat input count is not particularly limited as long as the heat input count is 2 or more. The heat input count is preferably 5 or more. In particular, the heat input count is preferably 8 to 16 per 10 mm in the welding direction.

### (a) Inclination Angle of Electrode α: 0° to 45°

The inclination angle α of the electrode (hereinafter also referred to as the electrode inclination angle α) is important from the viewpoint of forming a good welded portion. Here, the electrode inclination angle α is the angle of inclination from the thickness direction (normal direction to the interface of the material to be joined) of a straight line connecting the electrode tip to the heat input point, as illustrated in FIG. 4. Further, the electrode inclination angle α is determined relative to the reference angle (0°) in the thickness direction.

The inclination direction of the electrode is not particularly limited.

As mentioned above, in the method of joining stainless steel and copper according to an embodiment of the present disclosure, the full thickness of the copper is locally melted and solidified on the stainless steel. Here, when the electrode inclination angle α exceeds 45°, the heat input area becomes wider and the temperature around the heat input area increases excessively. This causes distortion around the joined portion due to thermal expansion and contraction, resulting in defects in the shape of the joined portion and defects in subsequent joining. The electrode inclination angle α is therefore 45° or less. The electrode inclination angle α is preferably 25° or less. A lower limit of the electrode inclination angle α is 0°. That is, the straight line connecting the electrode tip to the heat input point is parallel to the thickness direction.

(b) Electrode Height: More than 0 mm and 3.0 mm or Less

When the electrode height (that is, the distance in the thickness direction between the electrode tip and the material to be joined) is 0 mm, no arc is generated and welding cannot be performed. Further, when the electrode height exceeds 3.0 mm, the heat input region becomes wider and heat input is dispersed. This results in insufficient copper melting and insufficient joining. The electrode height is therefore more than 0 mm and 3.0 mm or less. When the electrode height is less than 0.5 mm, molten copper may come into contact with the electrode tip during joining, and may solidify and stick to the electrode. In such a case, the electrode needs to be pulled off the solidified copper, which reduces production efficiency. The electrode height is therefore preferably 0.5 mm or more. Further, when the electrode height exceeds 2.0 mm, the distance between the copper and the electrode tip becomes difficult to ascertain, making controlling the electrode height difficult. The electrode height is therefore preferably 2.0 mm or less.

(c) Position of Each Heat Input Point in Perpendicular-to-Welding Direction, in Mm: 0.5×0.03×I×d^{0.5}/t^{0.5} or More and L−0.5×0.03×I×d^{0.5}/t^{0.5} or Less

When heat input is applied in the immediate vicinity of the copper end of the overlapping portion of the material to be joined, the copper end melts and the desired airtightness and joint strength become unobtainable. On the other hand, when heat input is applied in the immediate vicinity of the stainless steel end of the overlapping portion, stainless steel is not present in a portion directly below the copper fusion zone, and therefore the desired joint strength becomes unobtainable. Accordingly, the position of each heat input position in the perpendicular-to-welding direction, in mm, is in a range from 0.5×0.03×I×d^{0.5}/t^{0.5} to L−0.5×0.03×I×d^{0.5}/t^{0.5}.

Here, t is the copper thickness in mm, I is the welding current in A, d is the welding time in s, and L is the width of the overlapping portion of the material to be joined where the stainless steel and copper overlap each other (the length of the interface between the stainless steel and the copper for each heat input point, in the perpendicular-to-welding direction). Further, each heat input position in the perpendicular-to-welding direction is set with the copper end of the overlapping portion as the reference position, 0, with the copper side as +ve and the stainless steel side as −ve.

Further, L is not particularly limited, but 5 mm to 30 mm is suitable, for example.

(d) Distance Interval in the Welding Direction Between Each Heat Input Point, in Mm: 0.1×{Dₖ₋₁×(1−0.2×t)} or More and Dₖ₋₁×(1−0.2×t) or Less

As mentioned above, in the method of joining stainless steel and copper according to an embodiment of the present disclosure, it is important to divide the heat inputs associated with welding into a plurality of localized and short-duration heat inputs. In particular, the distance interval in the welding direction between each heat input point (hereinafter also referred to as heat input point interval) is 0.1×{Dₖ₋₁×(1−0.2×t)} or more and Dₖ₋₁×(1−0.2×t) or less, in relation to the diameter Dₖ₋₁ of the welding point formed by the immediately preceding heat input (hereinafter also referred as the welding point diameter Dₖ₋₁) and the copper thickness t (mm).

Here, when the heat input point interval is less than 0.1×{Dₖ₋₁×(1−0.2×t)}, the heat input count to the same location increases, effectively resulting in excessive heat input to the same location. Accordingly, formation of an oxide coating on the surface of the stainless steel is insufficiently suppressed, and sufficient joint strength becomes unobtainable. Further, formation of the first liquid phase mainly composed of a stainless steel component is increased, leading to cracking of the welded portion. On the other hand, when the heat input point interval exceeds Dₖ₋₁×(1−0.2×t), the join between the stainless steel and the copper becomes discontinuous on the back face corresponding to the interface between stainless steel and copper, and sufficient airtightness becomes unobtainable. The heat input point interval is therefore 0.1×{Dₖ₋₁×(1−0.2×t)} or more and Dₖ₋₁×(1−0.2×t) or less. The heat input point interval is preferably 0.2×{Dₖ₋₁×(1−0.2×t)} or more. The heat input point interval is preferably 0.8×{Dₖ₋₁×(1−0.2×t)} or less.

Here, the heat input point interval is the distance between centers of adjacent heat input points. Further, the diameter of each welding point is calculated according to the procedure described above.

### (e) Time Interval Between Each Heat Input, in s: 100% or More of Welding Time, in s, of Immediately Preceding Heat Input

As mentioned above, in the method of joining stainless steel and copper according to an embodiment of the present disclosure, it is important to divide the heat inputs associated with welding into a plurality of localized and short-duration heat inputs. In particular, the time interval between each heat input (hereinafter also referred to as heat input time interval) is 100% or more of the welding time of the immediately preceding heat input (hereinafter also referred to as heat input time). When the heat input time interval becomes excessively short, specifically, when the heat input time interval is less than 100% of the heat input time, the amount of heat transferred to the vicinity of the heat input area exceeds the amount of heat released from the vicinity of the heat input area, and the temperature around the heat input area increases. Accordingly, formation of an oxide coating on the surface of the stainless steel is insufficiently suppressed, and sufficient joint strength becomes unobtainable. Further, formation of the first liquid phase mainly composed of a stainless steel component is increased, leading to cracking of the welded portion. Further, distortion around the joined portion due to thermal expansion and contraction may occur, resulting in defects in the shape of the joined portion and defects in subsequent joining. The heat input time interval is therefore 100% or more of the heat input time. The heat input time interval is preferably 250% or more of the heat input time. An upper limit of the heat input time interval is not particularly limited. From the viewpoint of production efficiency, the heat input time interval is preferably 20,000% or less of the heat input time.

Relationship between welding current I, in A, welding time d, in s, and copper thickness t, in mm at each heat input:

$${t}^{1.5} / ( 1 - 0.2 \times t ) \div 0.03 \leq I \times {d}^{0.5} \leq {t}^{1.5} / ( 1 - 0.2 \times t ) \div 0.03 \times 6 \qquad ( 4 )$$

When I×d^{0.5} is less than the left-hand side value of Expression (4), the amount of copper melted is insufficient and MF becomes less than 0.8t, resulting in insufficient joining of the stainless steel and the copper. On the other hand, when the value of I×d^{0.5} exceeds the right-hand side value of Expression (4), the Cu/Fe ratio of the welded portion becomes less than 10.0. That is, the stainless steel dissolves more into the weld metal. This leads to the formation of a larger amount of the first liquid phase mainly composed of a stainless steel component, leading to cracking of the welded portion. Further, the formation of oxide coating on the surface of the stainless steel is not sufficiently suppressed and sufficient joint strength is unobtainable. Therefore, at each heat input, the welding current I, in A, the welding time d, in s, and the copper thickness t, in mm, satisfy the relationship of Expression (4). I×d^{0.5} is preferably t^{1.5}/(1−0.2×t)÷0.03× 2 or more. Further, I×d^{0.5} is preferably t^{1.5}/(1−0.2×t)÷0.03× 5 or less. In particular, to obtain higher joint strength, to set the Cu/Fe ratio of the welded portion is 20.0 or more, and to set MF to 1.6t or more, the value of I×d^{0.5} is preferably in a range from t^{1.5}/(1−0.2×t)÷0.03×2 to t^{1.5}/(1−0.2×t)÷0.03×5.

When d is less than 0.05 s, the arc may not be stable. When d exceeds 2.00 s, heat is transferred around the heat input area and the surrounding temperature tends to increase. This may cause distortion around the joined portion due to thermal expansion and contraction, which may result in defects in the shape of the joined portion and defects in subsequent joining. Therefore, dis preferably 0.05 s or more. Further, d is preferably 2.00 s or less.

I is selected from t and d above to satisfy Expression (4). For example, I may selected from a range of 50 A to 500 A to satisfy Expression (4). From the viewpoint of avoiding distortion in the welded portion, when there are a range of possible values for d and I, setting d as low as possible and I as high as possible is preferable.

When pulse mode, upslope, downslope, and cratering are used for each heat input, the combined time of upslope time, welding time, downslope time, and cratering time is substituted for d, and a time average value of the welding current during that time is substituted for I to calculate the value of I×d^{0.5}.

Further, the start of each heat input may be done either as a touch start method or as a high-frequency start method. A hot arc may be used to start the heat input. However, the current and time taken at the start of such heat inputs are not included in the welding current I, in A, or the welding time d, in s, for each heat input.

Conditions other than those described above for TIG welding are not particularly limited and may be in accordance with a conventional method. For example, a typical inert gas may be used for shielding gas and back shielding gas, and 100% Ar is preferred.

Further, when the shielding gas flow rate is less than 1 L/min, the arc tends to become unstable. On the other hand, when the shielding gas flow rate exceeds 30 L/min, the shielding gas forms turbulence on the material to be joined. This turbulence, which entrains air, disturbs the inert gas atmosphere around the heat input zone, and defects can easily form in the welded portion. The shielding gas flow rate is therefore preferably 1 L/min to 30 L/min. The shielding gas flow rate is more preferably 25 L/min or less.

When the back shielding gas flow rate is less than 1 L/min, an oxide coating is formed on the stainless steel surface at the back side of the heat input location, and the corrosion resistance of the stainless steel tends to be reduced. On the other hand, when the back shielding gas flow rate exceeds 30 L/min, the back shielding gas forms turbulence on the material to be joined. This turbulence entrains air, which causes oxide coating to form on the stainless steel surface at the back side of the heat input location, which tends to reduce the corrosion resistance of the stainless steel. The back shielding gas flow rate is therefore preferably 1 L/min to 30 L/min. The back shielding gas flow rate is more preferably 25 L/min or less.

When a preflow time is set to 0.05 s or more, heat input is started when a sufficient inert gas atmosphere is formed around the heat input area. This helps stabilize the arc. The preflow time is therefore preferably 0.05 s or more. The preflow time is more preferably 0.15 s or more. An upper limit of preflow time is not particularly limited. Preflow time, for example, is preferably 10 s or less.

When postflow time is 0.10 s or more, formation of oxide coating directly above the welded portion can be suppressed and the appearance of the weld line can be improved. The postflow time is therefore preferably 0.10 s or more. The postflow time is more preferably 2.0 s or more. An upper limit of the postflow time is not particularly limited. The postflow time, for example, is preferably 10 s or less.

Further, repeated heat input causes the temperature of the copper material to be joined to increase excessively. This promotes copper melting, and as welding progresses, the bead width, that is, the maximum length of the welding point on the copper side surface of the material to be joined in the perpendicular-to-welding direction, may gradually increase. In such a case, for example, use of a chill block or cooling tube to cool the copper and stainless steel material to be joined is preferred. This suppresses bead width spreading and produces a welded portion that has excellent bead width stability. Here, “excellent bead width stability” means that the bead width change ratio expressed as Dₘₐₓ/Dₘᵢₙ is 1.4 or less, in particular 1.2 or less.

In addition to cooling the copper and stainless steel material to be joined, at least one of the following (f) to (h), for example, may be performed to preferably obtain a welded portion having excellent bead width stability.
(f) For each heat input, the welding current of the heat input is the welding current of the immediately preceding heat input or less.
(g) For each heat input, the welding time of the heat input is the welding time of the immediately preceding heat input or less.
(h) A long heat input time interval is provided between some heat inputs.

This does not include a case where the welding current, the welding time, and the time interval between heat inputs are constant for each heat input.
(f) For each heat input, the welding current of the heat input is the welding current of the immediately preceding heat input or less.

As the weld progresses, the welding current for each heat input is maintained or decreased. That is, for each heat input, the welding current of the heat input is preferably the welding current of the immediately preceding heat input or less. However, this does not include a case where the welding current is the same for all heat inputs. In other words, in all heat inputs, the welding current of the heat input is preferably the welding current of the immediately preceding heat input or less, and at least once out of all heat inputs, the welding current of the heat input is preferably less than the welding current of the immediately preceding heat input. This reduces the heat input amount as the temperature of the copper increases. That is, excessive melting of copper is suppressed. As a result, bead width spreading is suppressed and a welded portion that has excellent bead width stability is obtainable.
(g) For each heat input, the welding time of the heat input is the welding time of the immediately preceding heat input or less.

As the weld progresses, the welding time for each heat input is maintained or decreased. That is, for each heat input, the welding time of the heat input is preferably the welding time of the immediately preceding heat input or less. However, this does not include a case where the welding time is the same for all heat inputs. In other words, in all heat inputs, the welding time of the heat input is preferably the welding time of the immediately preceding heat input or less, and at least once out of all heat inputs, the welding time of the heat input is preferably less than the welding time of the immediately preceding heat input. This reduces the heat input amount as the temperature of the copper increases. That is, excessive melting of copper is suppressed. As a result, bead width spreading is suppressed and a welded portion that has excellent bead width stability is obtainable.
(h) A long heat input time interval is provided between some heat inputs.

A long heat input time interval is provided between some heat inputs. For example, suppressing excessive heating of the material to be joined by providing a long heat input time interval for each defined number of heat inputs is preferred. More specifically, an illustrative example may be a repeating pattern such as “three heat inputs at 1 s intervals, with a 5 s interval (long heat input time interval) after the third heat input”. This helps prevent excessively high temperatures in the material to be joined, and in particular suppresses excessive melting of copper. As a result, bead width spreading is suppressed and a welded portion that has excellent bead width stability is obtainable.

Here, a long heat input time interval means a longer heat input time interval than the normal heat input time interval. Further, the long heat input time interval is preferably 3.00 s to 6.00 s. The normal heat input time interval may be 0.8 s to 2.0 s, for example. Further, the frequency of the long heat input time intervals is preferably once every 2 to 4 heat input time intervals. The frequency of long heat input time intervals may be constant or not constant.

The length of the welding electrode protruding from the welding nozzle (hereinafter also referred to as the protrusion length) is preferably from −1 mm to 10 mm. In particular, when manual welding is used and a portion of the welding nozzle is placed over the copper surface of the material to be joined to facilitate control of the position and angle of the welding torch, the protrusion length is preferably-1 mm or more and less than 3 mm. When manual welding is carried out in a typical case without the above control, or when automated welding is carried out, the protrusion length is preferably 3 mm or more to facilitate operation of the welding torch or to set the electrode height by making the electrode tip easily visible. Further, in order to appropriately form an inert gas atmosphere, the protrusion length is preferably 10 mm or less.

Further, the tip angle of the welding electrode is preferably 45° or less from the viewpoint of ease of removal in case the electrode tip sticks to the molten weld pool. On the other hand, the tip angle of the welding electrode is preferably 15° or more from the viewpoint of reducing the frequency of electrode dressing and increasing production efficiency. The electrode diameter of the welding electrode is preferably 2.4 mm or less from the viewpoint of ease of aiming the heat input position. On the other hand, the electrode diameter of the welding electrode is preferably 1.2 mm or more from the viewpoint of securing the spot welding diameter. The type of welding electrode may be selected arbitrarily. For example, selection may be made from general-purpose electrodes such as thorium-tungsten, cerium-tungsten, lanthanum-tungsten, pure tungsten, and the like.

The method of joining stainless steel and copper according to an embodiment of the present disclosure may be implemented, for example, by using an arc spot mode of a TIG welder able to precisely control arc spot time. Further, the method of joining stainless steel and copper according to an embodiment of the present disclosure may be implemented by using a low-speed pulse welding mode with an adjusted pulse width in a TIG welder able to precisely adjust pulse width and pulse frequency over a wide range. Further, the method of joining stainless steel and copper according to an embodiment of the present disclosure may be implemented in any of the basic welding positions: flat position, vertical position, horizontal position, or overhead position. Therefore, in circumferential welding of pipes or tubes, welding may be performed without rotating the pipe or tube.

### [3] Method of Producing Stainless Steel and Copper Joined Body

The following describes a method of producing a stainless steel and copper joined body according to an embodiment of the present disclosure.

The method of producing a stainless steel and copper joined body according to an embodiment of the present disclosure includes
joining stainless steel and copper by the method of joining stainless steel and copper according to an embodiment of the present disclosure described above.

The method of producing a stainless steel and copper joined body according to an embodiment of the present disclosure allows production of the stainless steel and copper joined body according to an embodiment of the present disclosure.

### Examples

### Examples 1

Stainless steel sheets (SUS 443J1, as specified in JIS G 4305:2021) and phosphorous-deoxidized copper sheets (C1220, as specified in JIS H 3100:2018) (hereinafter also referred to simply as “copper sheets”) having the thicknesses listed in Table 1 were cut into 120 mm squares. For each test, a copper sheet was placed on a stainless steel sheet with the ends aligned in the welding direction with the overlap width L listed in Table 1, as the material to be joined. Next, an electrode was positioned on the copper side of the overlapping portion of the material to be joined, the stainless steel and the copper, and welding by TIG welding was carried out under a set of conditions including conditions listed in Table 1 to obtain a joined body of the stainless steel sheet and the copper sheet. The welding was carried out using a DA-300P TIG welder produced by Daihen Corporation. 100% Ar was used as the shielding gas and the back shielding gas, and the shielding gas flow rate and the back shielding gas flow rate were 25 L/min each. Preflow was 0.5 s and postflow was 3.0 s. Conditions other than those described were in accordance with a conventional method. Further, in Test No. 1-1 to 1-5, and 1-9 to 1-17, welding was carried out while the material to be joined was cooled by a chill block in order to prevent excessive temperature increase of the material to be joined. On the other hand, in Test No. 1-6 to 1-8 and 1-18, no cooling of the materials to be joined using a chill block or cooling tube was performed. The numerical values in Table 1, as well as in Tables 2, 3, 4, and 5, are rounded off as appropriate. Further, “Appropriate range of heat input point position” in Tables 1 and 2 indicates the appropriate range of “the position of each heat input point in the perpendicular-to-welding direction”, with the copper end of the overlapping portion as the reference position, 0, the copper side as +ve and the stainless steel side as −ve.

For each of Test No. 1-1 to 1-16, a plurality of heat inputs were all carried out under the same conditions. Further, for Test No. 1-17 and 1-18, TIG welding was carried out continuously (not divided into a plurality of heat inputs) at a welding speed of 75 mm/min with an arc length of 1.5 mm under a set of conditions including a welding current of 180 A and 140 A, respectively.

Using the obtained joined body of stainless steel sheet and copper sheet, the following were measured:
(I) Position of welded portion (whether or not located in the overlapping portion),
(II) Cu/Fe ratio of welded portion,
(III) Distance MF between fusion boundaries,
(IV) Diameter of welding points, and
(V) Average distance interval B of welding points.

The results are listed in Table 1. Here, “Overlapping portion” in the column (I) Position of welded portion means that the entire welded portion is located in the overlapping portion in the perpendicular-to-welding direction. Further, “Outside overlap” means that at least one portion of the welded portion is located outside the overlapping portion in the perpendicular-to-welding direction. In addition, for (IV), only the minimum diameter Dₘᵢₙ and maximum diameter Dₘₐₓ are listed as representative for the diameter of each welding point.

In the measurement of (II) Cu/Fe ratio of welded portion, and (III) Distance MF between fusion boundaries, a scanning electron microscope (SEM), Miniscope® (Miniscope is a registered trademark in Japan, other countries, or both) TM3030plus, produced by Hitachi High-Tech Corporation, and an energy-dispersive X-ray spectrometer (EDS) AZtecOne, produced by Oxford Instruments, Ltd., were used.

Further, (VI) Airtightness and (VII) Joint strength were measured as described above and evaluated according to the following criteria. The results are listed in Table 1.
(VI) Airtightness
Pass: 0.2 MPa or more
Fail: less than 0.2 MPa
(VII) Joint strength
Pass (particularly good, indicated as “Excellent” in the table): joint strength is 80% or more of the lower of the stainless steel and copper strengths
Pass: joint strength is 60% or more and less than 80% of the lower of the stainless steel and copper strengths
Fail: joint strength is less than 60% of the lower of the stainless steel and copper strengths

In the evaluation of (VI) airtightness, RectorSeal® (RectorSeal is a registered trademark in Japan, other countries, or both) from RectorSeal Corporation was used as putty.

TABLE 1

| | | | Heat input conditions | | | | | | | | |
|---|---|---|---|---|---|---|---|---|---|---|---|
| | Thickness of material | | | (a) | | (c) | | Appropriate | (d) | | |
| | to be joined (mm) | | | Electrode | (b) | Heat input | | range of heat | Heat input | | |
| | Stainless | Copper | | inclination | Electrode | point | Overlap | input point | distance | | |
| Test | steel | sheet | Heat input | angle α | height | position | width L | position | interval | 0.1 × {Dₖ₋₁ × | Dₖ₋₁ × |
| No. | sheet | t | division | (°) | (mm) | (mm) | (mm) | (mm) | (mm) | (1 − 0.2 × t)} | (1 − 0.2 × t) |
| 1-1 | 0.5 | 1.0 | Yes | 0 | 1.0 | +5.0 | 10 | +1.8~+8.2 | 1.0 | 0.28~0.30 | 2.80~2.96 |
| 1-2 | 0.3 | 1.0 | Yes | 10 | 1.0 | +5.0 | 15 | +2.7~+12.3 | 1.0 | 0.42~0.44 | 4.16~4.40 |
| 1-3 | 1.5 | 1.0 | Yes | 20 | 1.0 | +6.0 | 8 | +1.4~+6.6 | 1.7 | 0.21~0.22 | 2.08~2.16 |
| 1-4 | 0.1 | 0.5 | Yes | 30 | 0.5 | +2.0 | 5 | +1.6~+3.4 | 2.7 | 0.30~0.32 | 2.97~3.24 |
| 1-5 | 1.0 | 1.5 | Yes | 45 | 2.0 | +18.0 | 20 | +1.2~+18.8 | 0.2 | 0.17~0.18 | 1.68~1.82 |
| 1-6 | 0.5 | 1.0 | Yes | 0 | 1.0 | +5.0 | 10 | +1.8~+8.2 | 1.0 | 0.28~0.44 | 2.80~4.40 |
| 1-7 | 0.3 | 1.0 | Yes | 10 | 1.0 | +5.0 | 15 | +2.7~+12.3 | 1.0 | 0.42~0.53 | 4.16~5.28 |
| 1-8 | 1.5 | 1.0 | Yes | 20 | 1.0 | +6.0 | 8 | +1.4~+6.6 | 1.7 | 0.21~0.30 | 2.08~3.04 |
| 1-9 | 0.5 | 1.0 | Yes | 20 | 1.0 | −0.5 | 10 | +1.8~+8.2 | 1.0 | — | — |
| 1-10 | 0.5 | 1.0 | Yes | 20 | 1.0 | +9.0 | 10 | +1.8~+8.2 | 1.0 | — | — |
| 1-11 | 0.5 | 1.0 | Yes | 20 | 1.0 | +5.0 | 10 | +0.6~+9.4 | 0.5 | 0.07~0.09 | 0.72~0.88 |
| 1-12 | 0.5 | 1.0 | Yes | 20 | 1.0 | +5.0 | 10 | +4.2~+5.8 | 1.0 | 0.67~0.69 | 6.72~6.88 |
| 1-13 | 0.5 | 1.0 | Yes | 20 | 1.0 | +5.0 | 10 | +1.8~+8.2 | 3.0 | 0.28~0.29 | 2.80~2.88 |
| 1-14 | 0.5 | 1.0 | Yes | 20 | 1.0 | +5.0 | 10 | +1.8~+8.2 | 0.2 | 0.28~0.30 | 2.80~3.04 |
| 1-15 | 0.5 | 1.0 | Yes | 20 | 5.0 | +5.0 | 10 | +1.8~+8.2 | 0.5 | 0.06~0.07 | 0.64~0.72 |
| 1-16 | 0.5 | 1.0 | Yes | 20 | 1.0 | +5.0 | 10 | +1.8~+8.2 | 1.0 | 0.28~0.50 | 2.80~4.96 |
| 1-17 | 0.5 | 1.0 | No | 0 | 1.0 | +5.0 | 10 | — | — | — | — |
| 1-18 | 0.5 | 1.0 | No | 0 | 1.0 | +5.0 | 10 | — | — | — | — |

| | Heat input conditions | | | | | | | | |
|---|---|---|---|---|---|---|---|---|---|
| | | Heat | | | | | | | |
| | (e) | input time | | | | | | | |
| | Heat | interval ÷ | | | | | | | |
| | input time | welding | Welding | Welding | | Expression | Expression | Heat | |
| Test | interval | time × 100 | current I | time d | | (4) left- | (4) right- | input | |
| No. | (s) | (%) | (A) | (s) | I × d^{0.5} | side value | side value | count | Remarks |
| 1-1 | 2.00 | 500 | 190 | 0.40 | 120 | 42 | 250 | 80 | Example |
| 1-2 | 2.00 | 250 | 200 | 0.80 | 179 | 42 | 250 | 80 | Example |
| 1-3 | 0.72 | 288 | 190 | 0.25 | 95 | 42 | 250 | 47 | Example |
| 1-4 | 0.50 | 125 | 120 | 0.40 | 76 | 13 | 79 | 29 | Example |
| 1-5 | 0.25 | 100 | 200 | 0.25 | 100 | 87 | 525 | 400 | Example |
| 1-6 | 2.00 | 500 | 190 | 0.40 | 120 | 42 | 250 | 80 | Example |
| 1-7 | 2.00 | 250 | 200 | 0.80 | 179 | 42 | 250 | 80 | Example |
| 1-8 | 0.72 | 288 | 190 | 0.25 | 95 | 42 | 250 | 47 | Example |
| 1-9 | 2.00 | 500 | 190 | 0.40 | 120 | 42 | 250 | 80 | Comparative Example |
| 1-10 | 2.00 | 500 | 190 | 0.40 | 120 | 42 | 250 | 80 | Comparative Example |
| 1-11 | 2.00 | 2000 | 120 | 0.10 | 38 | 42 | 250 | 160 | Comparative Example |
| 1-12 | 4.00 | 200 | 200 | 2.00 | 283 | 42 | 250 | 80 | Comparative Example |
| 1-13 | 2.00 | 500 | 190 | 0.40 | 120 | 42 | 250 | 26 | Comparative Example |
| 1-14 | 2.00 | 500 | 190 | 0.40 | 120 | 42 | 250 | 400 | Comparative Example |
| 1-15 | 2.00 | 500 | 190 | 0.40 | 120 | 42 | 250 | 160 | Comparative Example |
| 1-16 | 0.20 | 50 | 190 | 0.40 | 120 | 42 | 250 | 80 | Comparative Example |
| 1-17 | — | — | 180 | 64.00 | 1440 | 42 | 250 | 1 | Comparative Example |
| 1-18 | — | — | 140 | 64.00 | 1120 | 42 | 250 | 1 | Comparative Example |

| | Joined body | | | | | |
|---|---|---|---|---|---|---|
| | | | | | (IV) | (IV) |
| | | | (III) | | Minimum | Maximum |
| | | (II) | Distance MF | | diameter | diameter |
| | (I) | Cu/Fe ratio | between fusion | | Dₘᵢₙ Of | Dₘₐₓ of |
| Test | Position of | of welded | boundaries | | welding points | welding points |
| No. | welded portion | portion | (mm) | 0.8t | (mm) | (mm) |
| 1-1 | Overlapping portion | 41.4 | 2.7 | 0.8 | 3.5 | 3.7 |
| 1-2 | Overlapping portion | 27.3 | 4.3 | 0.8 | 5.2 | 5.5 |
| 1-3 | Overlapping portion | 46.7 | 1.9 | 0.8 | 2.6 | 2.7 |
| 1-4 | Overlapping portion | 12.5 | 2.3 | 0.4 | 3.3 | 3.6 |
| 1-5 | Overlapping portion | 56.6 | 1.7 | 1.2 | 2.4 | 2.6 |
| 1-6 | Overlapping portion | 29.3 | 3.9 | 0.8 | 3.5 | 5.5 |
| 1-7 | Overlapping portion | 24.1 | 5.1 | 0.8 | 5.2 | 6.6 |
| 1-8 | Overlapping portion | 43.4 | 2.5 | 0.8 | 2.6 | 3.8 |
| 1-9 | Outside overlap | — | — | — | — | — |
| 1-10 | Outside overlap | — | — | — | — | — |
| 1-11 | Overlapping portion | 61.9 | 0.7 | 0.8 | 0.9 | 1.1 |
| 1-12 | Overlapping portion | 4.1 | 6.8 | 0.8 | 8.4 | 8.6 |
| 1-13 | Overlapping portion | 41.7 | 2.3 | 0.8 | 3.5 | 3.6 |
| 1-14 | Overlapping portion | 7.7 | 2.8 | 0.8 | 3.5 | 3.8 |
| 1-15 | Overlapping portion | 160.4 | 0.6 | 0.8 | 0.8 | 0.9 |
| 1-16 | Overlapping portion | 7.2 | 5.2 | 0.8 | 3.5 | 6.2 |
| 1-17 | Overlapping portion | 1.8 | 4.3 | 0.8 | — | — |
| 1-18 | Overlapping portion | 1.6 | 4.5 | 0.8 | — | — |

| | Joined body | | | | | |
|---|---|---|---|---|---|---|
| | (V) | | | | | |
| | Average distance | | | Evaluation result | | |
| | interval B of | | | | (VII) | |
| Test | welding points | | | (VI) | Joint | |
| No. | (mm) | 0.10MF | 1.25MF | Airtightness | strength | Remarks |
| 1-1 | 1.0 | 0.27 | 3.38 | Pass | Excellent | Example |
| 1-2 | 1.0 | 0.43 | 5.38 | Pass | Excellent | Example |
| 1-3 | 1.7 | 0.19 | 2.38 | Pass | Excellent | Example |
| 1-4 | 2.7 | 0.23 | 2.88 | Pass | Pass | Example |
| 1-5 | 0.2 | 0.17 | 2.13 | Pass | Pass | Example |
| 1-6 | 1.0 | 0.39 | 4.88 | Pass | Excellent | Example |
| 1-7 | 1.0 | 0.51 | 6.38 | Pass | Excellent | Example |
| 1-8 | 1.7 | 0.25 | 3.13 | Pass | Excellent | Example |
| 1-9 | — | — | — | Fail | Fail | Comparative Example |
| 1-10 | — | — | — | Pass | Fail | Comparative Example |
| 1-11 | 0.5 | 0.07 | 0.88 | Pass | Fail | Comparative Example |
| 1-12 | 1.0 | 0.68 | 8.50 | Fail | Fail | Comparative Example |
| 1-13 | 3.0 | 0.23 | 2.88 | Fail | Pass | Comparative Example |
| 1-14 | 0.2 | 0.28 | 3.50 | Fail | Fail | Comparative Example |
| 1-15 | 0.5 | 0.06 | 0.75 | Pass | Fail | Comparative Example |
| 1-16 | 1.0 | 0.52 | 6.50 | Fail | Fail | Comparative Example |
| 1-17 | — | 0.43 | 5.38 | Fail | Fail | Comparative Example |
| 1-18 | — | 0.45 | 5.63 | Fail | Fail | Comparative Example |

As indicated in Table 1, the desired airtightness and joint strength was obtained for all Examples. In other words, stainless steel and copper joined bodies that had sufficient joint strength were obtained without cracking or joining discontinuities in the welded portion. In particular, excellent joint strength was obtained for Test No. 1-1 to 1-3 and 1-6 to 1-8. As mentioned above, for all of the above Examples, a plurality of heat inputs were all performed under the same conditions. Separately, a plurality of heat inputs were performed under different conditions. Specifically, the heat input conditions were changed for each heat input based on the test conditions of the Examples. In this case also, it was confirmed that, when the conditions pertaining to (a) to (e) and Expression (4) are satisfied, the desired values for the Cu/Fe ratio of the welded portion, the distance MF between fusion boundaries, and the average distance interval B of welding points can be obtained, and the desired airtightness and joint strength can also be obtained.

In contrast, at least one of airtightness and joint strength were insufficient for all of the Comparative Examples.

That is, in the Comparative Example of Test No. 1-9, the heat input point position was less than the appropriate range, resulting in heat input too close to the copper end, and at least one portion of the welded portion was located outside the overlapping portion. Further, a lot of stainless steel melted into the welded portion, causing cracks in the welded portion, and the desired airtightness was not obtained. Further, joint strength was insufficient.

In the Comparative Example of Test No. 1-10, the heat input point position exceeded the appropriate range, resulting in heat input too close to the stainless steel end, and at least one portion of the welded portion was located outside the overlapping portion. Further, stainless steel was absent in a portion directly below the fusion zone of copper, and the desired joint strength was not obtained.

In the Comparative Example of Test No. 1-11, the lower limit of Expression (4) was not reached, resulting in the distance MF between fusion boundaries being less than the lower limit of Expression (1), and therefore the desired joint strength was not obtained.

In the Comparative Example of Test No. 1-12, the upper limit of Expression (4) was exceeded, resulting in excessive heat input, and the Cu/Fe ratio of the welded portion did not satisfy the appropriate range. As a result, the welded portion cracked and the desired airtightness was not obtained. Further, joint strength was insufficient.

In the Comparative Example of Test No. 1-13, the heat input distance interval was excessive and the average distance interval B of the welding points exceeded the appropriate range, resulting in discontinuity in the joining of the stainless steel and the copper, and the desired airtightness was not obtained.

In the Comparative Example of Test No. 1-14, the heat input distance interval was too small and the average distance interval B of the welding points was less than the appropriate range, and therefore the heat input was excessive. As a result, the Cu/Fe ratio of the welded portion was not within the appropriate range, causing cracking in the welded portion, and the desired airtightness was not obtained. Further, joint strength was insufficient.

In the Comparative Example of Test No. 1-15, the electrode height exceeded the appropriate range, resulting in insufficient copper melting, and the distance MF between the fusion boundaries was less than the lower limit of Expression (1), and therefore the desired joint strength was not obtained.

In the Comparative Example of Test No. 1-16, the heat input time interval was not within the appropriate range, and therefore the Cu/Fe ratio of the welded portion was not within the appropriate range, resulting in cracking in the welded portion, and the desired airtightness was not obtained. Further, joint strength was insufficient.

In the Comparative Examples of Test No. 1-17 and 1-18, the TIG welding was performed continuously under typical conditions (not divided into a plurality of heat inputs), resulting in excessive melting of the stainless steel. As a result, the Cu/Fe ratio of the welded portion was not within the appropriate range, causing cracking in the welded portion, and the desired airtightness was not obtained. Further, joint strength was insufficient.

### Examples 2

Stainless steel tubes (welded tubes made from SUS304, SUS316L, SUS443J1, SUS445J1, SUS430J1L, and SUS444 stainless steel sheets as specified in JIS G 4305:2021) having the outer diameters and thicknesses (wall thicknesses) listed in Table 2; and copper tubes (phosphorous-deoxidized copper tubes (C1220T) specified in JIS H 3300:2018) having the outer diameters and thicknesses (wall thicknesses) listed in Table 2 were cut into 300 mm lengths. For each test, a stainless steel tube was inserted into the copper tube so that the overlap width L listed in Table 2 was obtained, as the material to be joined. Next, an electrode was positioned on the copper side of the overlapping portion of the material to be joined, the stainless steel and the copper, and welding by TIG welding was carried out under a set of conditions including conditions listed in Table 2 to obtain a joined body of the stainless steel tube and the copper tube. The welding points were around the entire circumference of the overlapping portion (once round) so that the welded portion was formed around the entire circumference. Further, the welding was performed using YS-TIG200PACDC, a TIG welder produced by Heige Co., Ltd. 100% Ar was used as the shielding gas and the back shielding gas, and the shielding gas flow rate and the back shielding gas flow rate were 25 L/min each. Preflow was 0.5 s and postflow was 3.0 s. Conditions other than those described were in accordance with a conventional method. Further, in Test No. 2-1 to 2-6 and 2-8 to 2-10, the welding was performed while the materials to be joined were cooled by wrapping with a cooling tube connected to a chiller in order to prevent excessive temperature increase of the material to be joined. On the other hand, in Test No. 2-7, no cooling of the material to be joined using a chill block or cooling tube was performed.

Using the obtained joined body of stainless steel sheet and copper sheet, the following were measured:
(I) Position of welded portion (whether or not located in the overlapping portion),
(II) Cu/Fe ratio of welded portion,
(III) Distance MF between fusion boundaries,
(IV) Diameter of welding points, and
(V) Average distance interval B of welding points.

Results are listed in Table 2.

Further, (VI) Airtightness and (VII) Joint strength were measured as described above and evaluated according to the same criteria as in Examples 1. Results are listed in Table 2.

The conditions other than those described above and in Table 2 were the same as in Examples 1.

TABLE 2

| | | | | | | | Heat input conditions | | | | | | |
|---|---|---|---|---|---|---|---|---|---|---|---|---|---|
| | Outer diameter of | | Thickness of | | | | | | | (c) | | Appropriate | (d) |
| | material to be joined | | material to be joined | | Type of material | | | (a) | | Heat | | range of | Heat |
| | (mm) | | (mm) | | to be joined | | | Electrode | (b) | input | | heat input | input |
| | Stainless | | Stainless | | Stainless | | Heat | inclination | Electrode | point | Overlap | point | distance |
| Test | steel | Copper | steel | Copper | steel | Copper | input | angle α | height | position | width L | position | interval |
| No. | tube | tube | tube | tube t | tube | tube | division | (°) | (mm) | (mm) | (mm) | (mm) | (mm) |
| 2-1 | 10 | 12 | 0.5 | 1.0 | SUS443J1 | C1220T | Yes | 0 | 1.0 | +5.0 | 10 | +1.9~+8.1 | 1.0 |
| 2-2 | 10 | 12 | 0.5 | 1.0 | SUS304 | C1220T | Yes | 10 | 1.0 | +10.0 | 15 | +1.8~+13.2 | 1.5 |
| 2-3 | 5 | 6 | 0.3 | 0.5 | SUS445J1 | C1220T | Yes | 10 | 1.5 | +2.0 | 10 | +1.0~+9.0 | 0.4 |
| 2-4 | 5 | 6 | 0.3 | 0.5 | SUS430J1L | C1220T | Yes | 10 | 1.0 | +3.0 | 5 | +0.9~+4.1 | 0.8 |
| 2-5 | 12 | 15 | 1.0 | 1.5 | SUS316L | C1220T | Yes | 10 | 0.5 | +5.0 | 10 | +2.5~+7.5 | 2.0 |
| 2-6 | 12 | 15 | 1.0 | 1.5 | SUS444 | C1220T | Yes | 10 | 1.0 | +6.0 | 10 | +2.3~+7.7 | 0.8 |
| 2-7 | 10 | 12 | 0.5 | 1.0 | SUS443J1 | C1220T | Yes | 0 | 1.0 | +5.0 | 10 | +1.9~+8.1 | 1.0 |
| 2-8 | 10 | 12 | 0.5 | 1.0 | SUS304 | C1220T | Yes | 10 | 1.0 | +10.0 | 15 | +0.5~+14.5 | 0.5 |
| 2-9 | 10 | 12 | 0.5 | 1.0 | SUS304 | C1220T | Yes | 10 | 1.0 | +10.0 | 15 | +4.2~+10.8 | 1.5 |
| 2-10 | 10 | 12 | 0.5 | 1.0 | SUS304 | C1220T | Yes | 10 | 1.0 | +10.0 | 15 | +1.8~+13.2 | 3.0 |

| | Heat input conditions | | | | | | | | | | |
|---|---|---|---|---|---|---|---|---|---|---|---|
| | | | (e) | Heat input | | | | | | | |
| | | | Heat | time | | | | | | | |
| | | | input | interval ÷ | | | | | | | |
| | | | time | welding | Welding | Welding | | Expression | Expression | Heat | |
| Test | 0.1 × {Dₖ₋₁ × | Dₖ₋₁ × | interval | time × 100 | current I | time d | | (4) left- | (4) right | input | |
| No. | (1 − 0.2 × t)} | (1 − 0.2 × t) | (s) | (%) | (A) | (s) | I × d^{0.5} | side value | side value | count | Remarks |
| 2-1 | 0.29~0.31 | 2.88~3.12 | 2.00 | 500 | 200 | 0.40 | 126 | 42 | 250 | 38 | Example |
| 2-2 | 0.27~0.29 | 2.72~2.88 | 4.00 | 889 | 180 | 0.45 | 121 | 42 | 250 | 26 | Example |
| 2-3 | 0.19~0.20 | 1.89~1.98 | 0.30 | 300 | 150 | 0.10 | 47 | 13 | 79 | 48 | Example |
| 2-4 | 0.15~0.18 | 1.53~1.80 | 3.00 | 6000 | 200 | 0.05 | 45 | 13 | 79 | 24 | Example |
| 2-5 | 0.35~0.36 | 3.50~3.64 | 6.00 | 375 | 160 | 1.60 | 202 | 87 | 525 | 24 | Example |
| 2-6 | 0.30~0.32 | 3.01~3.15 | 2.50 | 278 | 200 | 0.90 | 190 | 87 | 525 | 59 | Example |
| 2-7 | 0.29~0.44 | 2.88~4.40 | 2.00 | 500 | 200 | 0.40 | 126 | 42 | 250 | 38 | Example |
| 2-8 | 0.06~0.07 | 0.64~0.72 | 4.00 | 8000 | 150 | 0.05 | 34 | 42 | 250 | 76 | Comparative |
| | | | | | | | | | | | Example |
| 2-9 | 0.65~0.68 | 6.48~6.80 | 4.00 | 200 | 200 | 2.00 | 283 | 42 | 250 | 26 | Comparative |
| | | | | | | | | | | | Example |
| 2-10 | 0.27~0.28 | 2.72~2.80 | 4.00 | 889 | 180 | 0.45 | 121 | 42 | 250 | 13 | Comparative |
| | | | | | | | | | | | Example |

| | Joined body | | | | | |
|---|---|---|---|---|---|---|
| | | | | | (IV) | (IV) |
| | | | (III) | | Minimum | Maximum |
| | | (II) | Distance MF | | diameter | diameter |
| | (I) | Cu/Fe ratio | between fusion | | Dₘᵢₙ of | Dₘₐₓ of |
| Test | Position of | of welded | boundaries | | welding points | welding points |
| No. | welded portion | portion | (mm) | 0.8t | (mm) | (mm) |
| 2-1 | Overlapping portion | 38.6 | 3.1 | 0.8 | 3.6 | 3.9 |
| 2-2 | Overlapping portion | 42.5 | 2.6 | 0.8 | 3.4 | 3.6 |
| 2-3 | Overlapping portion | 33.3 | 1.9 | 0.4 | 2.1 | 2.2 |
| 2-4 | Overlapping portion | 34.6 | 1.6 | 0.4 | 1.7 | 2.0 |
| 2-5 | Overlapping portion | 47.7 | 3.4 | 1.2 | 5.0 | 5.2 |
| 2-6 | Overlapping portion | 50.2 | 3.0 | 1.2 | 4.3 | 4.5 |
| 2-7 | Overlapping portion | 32.2 | 4.3 | 0.8 | 3.6 | 5.5 |
| 2-8 | Overlapping portion | 58.8 | 0.6 | 0.8 | 0.8 | 0.9 |
| 2-9 | Overlapping portion | 2.0 | 6.7 | 0.8 | 8.1 | 8.5 |
| 2-10 | Overlapping portion | 45.0 | 2.0 | 0.8 | 3.4 | 3.5 |

| | Joined body | | | | | |
|---|---|---|---|---|---|---|
| | (V) | | | | | |
| | Average distance | | | Evaluation result | | |
| | interval B of | | | | (VII) | |
| Test | welding points | | | (VI) | Joint | |
| No. | (mm) | 0.10MF | 1.25MF | Airtightness | strength | Remarks |
| 2-1 | 1.0 | 0.31 | 3.88 | Pass | Excellent | Example |
| 2-2 | 1.5 | 0.26 | 3.25 | Pass | Excellent | Example |
| 2-3 | 0.4 | 0.19 | 2.38 | Pass | Excellent | Example |
| 2-4 | 0.8 | 0.16 | 2.00 | Pass | Excellent | Example |
| 2-5 | 2.0 | 0.34 | 4.25 | Pass | Excellent | Example |
| 2-6 | 0.8 | 0.30 | 3.75 | Pass | Excellent | Example |
| 2-7 | 1.0 | 0.43 | 5.38 | Pass | Excellent | Example |
| 2-8 | 0.5 | 0.06 | 0.75 | Pass | Fail | Comparative Example |
| 2-9 | 1.5 | 0.67 | 8.38 | Fail | Fail | Comparative Example |
| 2-10 | 3.0 | 0.20 | 2.50 | Fail | Pass | Comparative Example |

As indicated in Table 2, the desired airtightness and joint strength was obtained for all Examples. In other words, stainless steel and copper joined bodies that had sufficient joint strength were obtained without cracking or joining discontinuities in the welded portion. Further, in particular, excellent joint strength was obtained in all Examples. In all of the above Examples, the plurality of heat inputs were all performed under the same conditions. Separately, a plurality of heat inputs were performed under different conditions. Specifically, the heat input conditions were changed for each heat input based on the test conditions of the Examples. In this case also, it was confirmed that, when the conditions pertaining to (a) to (e) and Expression (4) are satisfied, the desired values for the Cu/Fe ratio of the welded portion, the distance MF between fusion boundaries, and the average distance interval B of welding points can be obtained, and the desired airtightness and joint strength can also be obtained.

In contrast, at least one of airtightness and joint strength were insufficient for all of the Comparative Examples.

That is, in the Comparative Example of Test No. 2-8, the lower limit of Expression (4) was not reached, resulting in the distance MF between fusion boundaries being less than the lower limit of Expression (1), and therefore the desired joint strength was not obtained.

In the Comparative Example of Test No. 2-9, the upper limit of Expression (4) was exceeded, resulting in excessive heat input, and the Cu/Fe ratio of the welded portion did not satisfy the appropriate range. As a result, the welded portion cracked and the desired airtightness was not obtained. Further, joint strength was insufficient.

In the Comparative Example of Test No. 2-10, the heat input distance interval was excessive and the average distance interval B of the welding points exceeded the appropriate range, resulting in discontinuity in the joining of the stainless steel and the copper, and the desired airtightness was not obtained.

### Examples 3

Stainless steel sheets (SUS443J1 specified in JIS G 4305:2021) having a length of 40 mm, a width of 50 mm, and a thickness of 1.5 mm, and phosphorous-deoxidized copper sheets (C1220 specified in JIS H 3100:2018) having a length of 40 mm, a width of 40 mm, and a thickness of 0.5 mm (hereinafter also referred to simply as “copper sheets”) were cut out. For each test, a copper sheet was placed on the stainless steel sheet so that a region having a width of 20 mm overlapped, that is, the overlap width L was 20 mm, as the material to be joined. Next, an electrode was positioned on the copper side of the overlapping portion of the material to be joined, the stainless steel and the copper, and welding by TIG welding was carried out under a set of conditions including conditions listed in Tables 3 and 4 to obtain a joined body of the stainless steel sheet and the copper sheet. Further, (a) electrode tilt angle: 0°, (b) electrode height: 1.0 mm, and (c) heat input point position: +10.0 mm were set. (c) Heat input point positions were all in the range from 0.5×0.03×I×d^{0.5}/t^{0.5} to L−0.5×0.03×I×d^{0.5}/t^{0.5}. The heat input count was 16 for each test. The welder used was YS-TIG200PACDC, a TIG welder produced by Heige Co., Ltd. As the shielding gas and back shielding gas, 100% Ar was used at a gas flow rate of 25 L/min, respectively. Preflow was 0.3 s and postflow was 2.0 s. Conditions other than those described were in accordance with a conventional method. In Test No. 3-3 and Test No. 3-4, the material to be joined was cooled using a chill block. On the other hand, in Test No. 3-1 and Test No. 3-2, no cooling of the material to be joined using a chill block or cooling tube was performed.

Here, Condition A in Table 4 is a set of conditions where (f) to (h), as described above, were not satisfied and the welding current, the welding time, and the heat input time interval for each heat input were constant. Further, Condition B in Table 4 is a set of conditions where (f) and (h) were satisfied.

Using the obtained joined body of the stainless steel tube and the copper tube, the following were measured:
(I) Position of welded portion (whether or not located in the overlapping portion),
(II) Cu/Fe ratio of welded portion,
(III) Distance MF between fusion boundaries,
(IV) Diameter of welding points, and
(V) Average distance interval B of welding points.

The results are listed in Table 3.

Further, (VI) Airtightness and (VII) Joint strength were measured as described above and evaluated according to the same criteria as in Examples 1. The results are listed in Table 3.

Further, at the copper side surface of the joined body, the bead width change ratio (Dₘᵢₙ/Dₘₐₓ) was calculated from the minimum diameter Dₘᵢₙ and the maximum diameter Dₘₐₓ of the welding points. The results are listed in

TABLE 3
Table 3.

| | | | | | Joined body | | | | |
|---|---|---|---|---|---|---|---|---|---|
| | Heat input conditions | | | | | | (III) | | Minimum |
| | | (d) | | | | (II) | Distance MF | | diameter |
| | | Heat input | | | | Cu/Fe | between | | Dₘᵢₙ of |
| | Heat input | point | | | (I) | ratio of | fusion | | welding |
| Test | conditions | interval | 0.1 × {Dₖ₋₁ × | Dₖ₋₁ × | Position of | welded | boundaries | | points |
| No. | (Table 5) | (mm) | (1 − 0.2 × t)} | (1 − 0.2 × t) | welded portion | portion | (mm) | 0.8t | (mm) |
| 3-1 | Condition A | 1.5 | 0.21~0.31 | 2.07~3.06 | Overlapping portion | 15.2 | 2.5 | 0.4 | 2.3 |
| 3-2 | Condition B | 1.5 | 0.21~0.24 | 2.07~2.43 | Overlapping portion | 22.7 | 2.1 | 0.4 | 2.3 |
| 3-3 | Condition A | 1.5 | 0.21~0.23 | 2.07~2.25 | Overlapping portion | 27.3 | 2.0 | 0.4 | 2.3 |
| 3-4 | Condition B | 1.5 | 0.21~0.21 | 2.07~2.07 | Overlapping portion | 29.6 | 1.7 | 0.4 | 2.3 |

| | Joined body | | | | | | | |
|---|---|---|---|---|---|---|---|---|
| | Maximum | | | | | | | |
| | diameter | (V) | | | | | | |
| | Dₘₐₓ of | Average distance | | | Evaluation result | | | |
| | welding | interval B of | | | | | (VIII) | |
| Test | points | welding points | | | (VI) | (VII) | Bead width | |
| No. | (mm) | (mm) | 0.10MF | 1.25MF | Airtightness | Joint strength | change ratio | Remarks |
| 3-1 | 3.4 | 1.5 | 0.25 | 3.13 | Pass | Excellent | 1.5 | Example |
| 3-2 | 2.7 | 1.5 | 0.21 | 2.63 | Pass | Excellent | 1.2 | Example |
| 3-3 | 2.5 | 1.5 | 0.20 | 2.50 | Pass | Excellent | 1.1 | Example |
| 3-4 | 2.3 | 1.5 | 0.17 | 2.13 | Pass | Excellent | 1.0 | Example |

TABLE 4

| | | | | | | | (e) | |
|---|---|---|---|---|---|---|---|---|
| | | | | | | | | Heat input |
| | | | | | | | Heat input | time interval ÷ |
| | | Welding | Welding | | Expression | Expression | time | welding time |
| | | current I | time d | | (4) left- | (4) right- | interval | d × 100 |
| Conditions | | (A) | (s) | I × d^{0.5} | side value | side value | (s) | (%) |
| Condition A | 1st heat input conditions | 180 | 0.10 | 56.9 | 13.1 | 78.6 | | |
| | 2nd heat input conditions | 180 | 0.10 | 56.9 | | | 0.85 | 850 |
| | 3rd heat input conditions | 180 | 0.10 | 56.9 | | | 0.85 | 850 |
| | 4th heat input conditions | 180 | 0.10 | 56.9 | | | 0.85 | 850 |
| | 5th heat input conditions | 180 | 0.10 | 56.9 | | | 0.85 | 850 |
| | 6th heat input conditions | 180 | 0.10 | 56.9 | | | 0.85 | 850 |
| | 7th heat input conditions | 180 | 0.10 | 56.9 | | | 0.85 | 850 |
| | 8th heat input conditions | 180 | 0.10 | 56.9 | | | 0.85 | 850 |
| | 9th heat input conditions | 180 | 0.10 | 56.9 | | | 0.85 | 850 |
| | 10th heat input conditions | 180 | 0.10 | 56.9 | | | 0.85 | 850 |
| | 11th heat input conditions | 180 | 0.10 | 56.9 | | | 0.85 | 850 |
| | 12th heat input conditions | 180 | 0.10 | 56.9 | | | 0.85 | 850 |
| | 13th heat input conditions | 180 | 0.10 | 56.9 | | | 0.85 | 850 |
| | 14th heat input conditions | 180 | 0.10 | 56.9 | | | 0.85 | 850 |
| | 15th heat input conditions | 180 | 0.10 | 56.9 | | | 0.85 | 850 |
| | 16th heat input conditions | 180 | 0.10 | 56.9 | | | 0.85 | 850 |
| Condition B | 1st heat input conditions | 180 | 0.10 | 56.9 | 13.1 | 78.6 | | |
| | 2nd heat input conditions | 180 | 0.10 | 56.9 | | | 0.85 | 850 |
| | 3rd heat input conditions | 170 | 0.10 | 53.8 | | | 0.85 | 850 |
| | 4th heat input conditions | 170 | 0.10 | 53.8 | | | 5.85 | 5850 |
| | 5th heat input conditions | 170 | 0.10 | 53.8 | | | 0.85 | 850 |
| | 6th heat input conditions | 160 | 0.10 | 50.6 | | | 0.85 | 850 |
| | 7th heat input conditions | 160 | 0.10 | 50.6 | | | 5.85 | 5850 |
| | 8th heat input conditions | 160 | 0.10 | 50.6 | | | 0.85 | 850 |
| | 9th heat input conditions | 160 | 0.10 | 50.6 | | | 0.85 | 850 |
| | 10th heat input conditions | 150 | 0.10 | 47.4 | | | 5.85 | 5850 |
| | 11th heat input conditions | 150 | 0.10 | 47.4 | | | 0.85 | 850 |
| | 12th heat input conditions | 150 | 0.10 | 47.4 | | | 0.85 | 850 |
| | 13th heat input conditions | 150 | 0.10 | 47.4 | | | 5.85 | 5850 |
| | 14th heat input conditions | 150 | 0.10 | 47.4 | | | 0.85 | 850 |
| | 15th heat input conditions | 150 | 0.10 | 47.4 | | | 0.85 | 850 |
| | 16th heat input conditions | 150 | 0.10 | 47.4 | | | 0.85 | 850 |
| Condition C | 1st heat input conditions | 220 | 0.53 | 160.2 | 41.7 | 250.0 | | |
| | 2nd heat input conditions | 220 | 0.53 | 160.2 | | | 0.90 | 170 |
| | 3rd heat input conditions | 220 | 0.53 | 160.2 | | | 0.90 | 170 |
| | 4th heat input conditions | 220 | 0.53 | 160.2 | | | 0.90 | 170 |
| | 5th heat input conditions | 220 | 0.53 | 160.2 | | | 0.90 | 170 |
| | 6th heat input conditions | 220 | 0.53 | 160.2 | | | 0.90 | 170 |
| | 7th heat input conditions | 220 | 0.53 | 160.2 | | | 0.90 | 170 |
| | 8th heat input conditions | 220 | 0.53 | 160.2 | | | 0.90 | 170 |
| | 9th heat input conditions | 220 | 0.53 | 160.2 | | | 0.90 | 170 |
| | 10th heat input conditions | 220 | 0.53 | 160.2 | | | 0.90 | 170 |
| | 11th heat input conditions | 220 | 0.53 | 160.2 | | | 0.90 | 170 |
| | 12th heat input conditions | 220 | 0.53 | 160.2 | | | 0.90 | 170 |
| | 13th heat input conditions | 220 | 0.53 | 160.2 | | | 0.90 | 170 |
| Condition D | 1st heat input conditions | 220 | 0.53 | 160.2 | 41.7 | 250.0 | | |
| | 2nd heat input conditions | 220 | 0.35 | 130.2 | | | 0.90 | 170 |
| | 3rd heat input conditions | 220 | 0.35 | 130.2 | | | 0.90 | 257 |
| | 4th heat input conditions | 220 | 0.35 | 130.2 | | | 0.90 | 257 |
| | 5th heat input conditions | 220 | 0.21 | 100.8 | | | 0.90 | 257 |
| | 6th heat input conditions | 220 | 0.21 | 100.8 | | | 0.90 | 429 |
| | 7th heat input conditions | 220 | 0.21 | 100.8 | | | 0.90 | 429 |
| | 8th heat input conditions | 220 | 0.21 | 100.8 | | | 0.90 | 429 |
| | 9th heat input conditions | 220 | 0.21 | 100.8 | | | 0.90 | 429 |
| | 10th heat input conditions | 220 | 0.21 | 100.8 | | | 0.90 | 429 |
| | 11th heat input conditions | 220 | 0.21 | 100.8 | | | 0.90 | 429 |
| | 12th heat input conditions | 220 | 0.21 | 100.8 | | | 0.90 | 429 |
| | 13th heat input conditions | 220 | 0.21 | 100.8 | | | 0.90 | 429 |
| Condition E | 1st heat input conditions | 220 | 0.53 | 160.2 | 41.7 | 250.0 | | |
| | 2nd heat input conditions | 210 | 0.53 | 152.9 | | | 0.90 | 170 |
| | 3rd heat input conditions | 200 | 0.53 | 145.6 | | | 0.90 | 170 |
| | 4th heat input conditions | 200 | 0.53 | 145.6 | | | 0.90 | 170 |
| | 5th heat input conditions | 190 | 0.53 | 138.3 | | | 0.90 | 170 |
| | 6th heat input conditions | 190 | 0.53 | 138.3 | | | 0.90 | 170 |
| | 7th heat input conditions | 180 | 0.53 | 131.0 | | | 0.90 | 170 |
| | 8th heat input conditions | 180 | 0.53 | 131.0 | | | 0.90 | 170 |
| | 9th heat input conditions | 170 | 0.53 | 123.8 | | | 0.90 | 170 |
| | 10th heat input conditions | 170 | 0.53 | 123.8 | | | 0.90 | 170 |
| | 11th heat input conditions | 170 | 0.53 | 123.8 | | | 0.90 | 170 |
| | 12th heat input conditions | 170 | 0.53 | 123.8 | | | 0.90 | 170 |
| | 13th heat input conditions | 170 | 0.53 | 123.8 | | | 0.90 | 170 |
| Condition F | 1st heat input conditions | 220 | 0.53 | 160.2 | 41.7 | 250.0 | | |
| | 2nd heat input conditions | 220 | 0.53 | 160.2 | | | 0.90 | 170 |
| | 3rd heat input conditions | 220 | 0.53 | 160.2 | | | 0.90 | 170 |
| | 4th heat input conditions | 220 | 0.53 | 160.2 | | | 0.90 | 170 |
| | 5th heat input conditions | 220 | 0.53 | 160.2 | | | 2.90 | 547 |
| | 6th heat input conditions | 220 | 0.53 | 160.2 | | | 0.90 | 170 |
| | 7th heat input conditions | 220 | 0.53 | 160.2 | | | 0.90 | 170 |
| | 8th heat input conditions | 220 | 0.53 | 160.2 | | | 0.90 | 170 |
| | 9th heat input conditions | 220 | 0.53 | 160.2 | | | 2.90 | 547 |
| | 10th heat input conditions | 220 | 0.53 | 160.2 | | | 0.90 | 170 |
| | 11th heat input conditions | 220 | 0.53 | 160.2 | | | 0.90 | 170 |
| | 12th heat input conditions | 220 | 0.53 | 160.2 | | | 0.90 | 170 |
| | 13th heat input conditions | 220 | 0.53 | 160.2 | | | 2.90 | 547 |
| Condition G | 1st heat input conditions | 220 | 0.53 | 160.2 | 41.7 | 250.0 | | |
| | 2nd heat input conditions | 210 | 0.53 | 152.9 | | | 0.90 | 170 |
| | 3rd heat input conditions | 200 | 0.53 | 145.6 | | | 0.90 | 170 |
| | 4th heat input conditions | 200 | 0.53 | 145.6 | | | 0.90 | 170 |
| | 5th heat input conditions | 200 | 0.35 | 118.3 | | | 0.90 | 170 |
| | 6th heat input conditions | 200 | 0.35 | 118.3 | | | 0.90 | 257 |
| | 7th heat input conditions | 200 | 0.35 | 118.3 | | | 0.90 | 257 |
| | 8th heat input conditions | 200 | 0.35 | 118.3 | | | 0.90 | 257 |
| | 9th heat input conditions | 200 | 0.21 | 91.7 | | | 0.90 | 257 |
| | 10th heat input conditions | 200 | 0.21 | 91.7 | | | 0.90 | 429 |
| | 11th heat input conditions | 200 | 0.21 | 91.7 | | | 0.90 | 429 |
| | 12th heat input conditions | 200 | 0.21 | 91.7 | | | 0.90 | 429 |
| | 13th heat input conditions | 200 | 0.21 | 91.7 | | | 0.90 | 429 |
| Condition H | 1st heat input conditions | 220 | 0.53 | 160.2 | 41.7 | 250.0 | | |
| | 2nd heat input conditions | 220 | 0.53 | 160.2 | | | 0.90 | 170 |
| | 3rd heat input conditions | 220 | 0.35 | 130.2 | | | 0.90 | 170 |
| | 4th heat input conditions | 220 | 0.35 | 130.2 | | | 0.90 | 257 |
| | 5th heat input conditions | 220 | 0.35 | 130.2 | | | 8.90 | 2543 |
| | 6th heat input conditions | 220 | 0.35 | 130.2 | | | 0.90 | 257 |
| | 7th heat input conditions | 220 | 0.21 | 100.8 | | | 0.90 | 257 |
| | 8th heat input conditions | 220 | 0.21 | 100.8 | | | 0.90 | 429 |
| | 9th heat input conditions | 220 | 0.21 | 100.8 | | | 8.90 | 4238 |
| | 10th heat input conditions | 220 | 0.21 | 100.8 | | | 0.90 | 429 |
| | 11th heat input conditions | 220 | 0.21 | 100.8 | | | 0.90 | 429 |
| | 12th heat input conditions | 220 | 0.21 | 100.8 | | | 0.90 | 429 |
| | 13th heat input conditions | 220 | 0.21 | 100.8 | | | 8.90 | 4238 |
| Condition I | 1st heat input conditions | 220 | 0.53 | 160.2 | 41.7 | 250.0 | | |
| | 2nd heat input conditions | 220 | 0.53 | 160.2 | | | 0.90 | 170 |
| | 3rd heat input conditions | 220 | 0.53 | 160.2 | | | 0.90 | 170 |
| | 4th heat input conditions | 200 | 0.35 | 118.3 | | | 3.90 | 736 |
| | 5th heat input conditions | 200 | 0.35 | 118.3 | | | 0.90 | 257 |
| | 6th heat input conditions | 200 | 0.35 | 118.3 | | | 0.90 | 257 |
| | 7th heat input conditions | 200 | 0.35 | 118.3 | | | 3.90 | 1114 |
| | 8th heat input conditions | 200 | 0.35 | 118.3 | | | 0.90 | 257 |
| | 9th heat input conditions | 200 | 0.35 | 118.3 | | | 0.90 | 257 |
| | 10th heat input conditions | 190 | 0.21 | 87.1 | | | 3.90 | 1114 |
| | 11th heat input conditions | 190 | 0.21 | 87.1 | | | 0.90 | 429 |
| | 12th heat input conditions | 190 | 0.21 | 87.1 | | | 0.90 | 429 |
| | 13th heat input conditions | 190 | 0.21 | 87.1 | | | 3.90 | 1857 |

As indicated in Table 3, the desired airtightness and joint strength was obtained for all Examples. In other words, stainless steel and copper joined bodies that had sufficient joint strength were obtained without cracking or joining discontinuities in the welded portion. Further, excellent airtightness and in particular, excellent joint strength were obtained for all Examples. Further, in Test No. 3-1, where the material to be joined was not cooled, the bead width change ratio was 1.5, but in Test No. 3-2, where the material to be joined was also not cooled, the widening of bead width as welding progressed was suppressed by satisfying (f) and (h) as described above, and a stainless steel and copper joined body having excellent bead width stability was obtained. In Test No. 3-3, where the material to be joined was cooled, the widening of the bead width was suppressed when compared to Test No. 3-1, where no cooling was performed. Further, in Test No. 3-4, where (f) and (h) were satisfied, as described above, along with cooling of the material to be joined, the bead width spread was the smallest.

### Examples 4

Stainless steel tubes (welded tubes made from SUS304 stainless steel sheets as specified in JIS G 4305:2021) having an outer diameter of 10 mm, a thickness (wall thickness) of 0.5 mm, and a length of 500 mm, and copper tubes (phosphorous-deoxidized copper tubes (C1220T) as specified in JIS H 3300:2.018) having an outer diameter of 12 mm, a thickness (wall thickness) of 1.0 mm, and a length of 500 mm, were cut out. For each test, a stainless steel tube was inserted into the copper tube so that the lengths overlapped by 10 mm, that is, the overlap width L was 10 mm, as the material to be joined. Next, an electrode was positioned on the copper side of the overlapping portion of the material to be joined, the stainless steel and the copper, and welding by TIG welding was carried out under a set of conditions including conditions listed in Tables 4 and 5 to obtain a joined body of the stainless steel tube and the copper tube. The welding points were around the entire circumference of the overlapping portion (once round) so that the welded portion was formed around the entire circumference. Further, (a) electrode tilt angle: 0°, (b) electrode height: 1.0 mm, and (c) heat input point position: +5.0 mm were set. (c) Heat input point positions were all in the range from 0.5×0.03×I×d^{0.5}/t^{0.5} to L−0.5×0.03×I×d^{0.5}/t^{0.5}. The heat input count was 13 for each test. The welder used was Pipe Ace, a TIG welder produced by Matsumoto Kikai Co., Ltd. As the shielding gas and back shielding gas, 100% Ar was used at a gas flow rate of 25 L/min, respectively. Preflow was 5.0 s and postflow was 6.0 s. Conditions other than those described were in accordance with a conventional method. Cooling of the material to be joined using a chill block or cooling tube was not performed.

Here, Condition C in Table 4 is a set of conditions where (f) to (h), as described above, were not satisfied and the welding current, the welding time, and the heat input time interval for each heat input were constant. Further, Condition D in Table 4 is a set of conditions where (g) was satisfied, Condition E is a set of conditions where (f) was satisfied, Condition F is a set of conditions where (h) was satisfied, Condition G is a set of conditions where (f) and (g) were satisfied, Condition H is a set of conditions where (g) and (h) were satisfied, and Condition I is a set of conditions where (f), (g) and (h) were satisfied.

Using the obtained joined body of the stainless steel tube and the copper tube, the following were measured:
(I) Position of welded portion (whether or not located in the overlapping portion),
(II) Cu/Fe ratio of welded portion,
(III) Distance MF between fusion boundaries,
(IV) Diameter of welding points, and
(V) Average distance interval B of welding points.

The results are listed in Table 5.

Further, (VI) Airtightness and (VII) Joint strength were measured as described above and evaluated according to the same criteria as in Examples 1. The results are listed in Table 5.

Further, at the copper side surface of the joined body, the bead width change ratio (Dₘᵢₙ/Dₘₐₓ) was calculated from the minimum diameter Dₘᵢₙ and the maximum diameter Dₘₐₓ of the welding points. The results are listed in Table 5.

TABLE 5

| | | | | | Joined body | | | | |
|---|---|---|---|---|---|---|---|---|---|
| | Heat input conditions | | | | | | (III) | | Minimum |
| | | (d) | | | | (II) | Distance MF | | diameter |
| | | Heat input | | | | Cu/Fe | between | | Dₘᵢₙ of |
| | Heat input | point | | | (I) | ratio of | fusion | | welling |
| Test | conditions | interval | 0.1 × {Dₖ₋₁ × | Dₖ₋₁ × | Position of | welled | boundaries | | points |
| No. | (Table 5) | (mm) | (1 − 0.2 × t)} | (1 − 0.2 × t) | welded portion | portion | (mm) | 0.8t | (mm) |
| 4-1 | Condition C | 3.0 | 0.38~0.52 | 3.76~5.20 | Overlapping portion | 20.3 | 4.6 | 0.8 | 4.7 |
| 4-2 | Condition D | 3.0 | 0.38~0.46 | 3.76~4.56 | Overlapping portion | 25.5 | 4.1 | 0.8 | 4.7 |
| 4-3 | Condition E | 3.0 | 0.38~0.46 | 3.76~4.64 | Overlapping portion | 27.3 | 3.8 | 0.8 | 4.7 |
| 4-4 | Condition F | 3.0 | 0.38~0.44 | 3.76~4.40 | Overlapping portion | 28.8 | 3.5 | 0.8 | 4.7 |
| 4-5 | Condition G | 3.0 | 0.38~0.42 | 3.76~4.16 | Overlapping portion | 31.5 | 3.4 | 0.8 | 4.7 |
| 4-6 | Condition H | 3.0 | 0.38~0.40 | 3.76~4.00 | Overlapping portion | 32.6 | 3.4 | 0.8 | 4.7 |
| 4-7 | Condition I | 3.0 | 0.38~0.38 | 3.76~3.84 | Overlapping portion | 33.4 | 3.2 | 0.8 | 4.7 |

| | Joined body | | | | | | | |
|---|---|---|---|---|---|---|---|---|
| | Maximum | | | | | | | |
| | diameter | (V) | | | | | | |
| | Dₘₐₓ of | Average distance | | | Evaluation result | | | |
| | welding | interval B of | | | | | (VIII) | |
| Test | points | welding points | | | (VI) | (VII) | Bead width | |
| No. | (mm) | (mm) | 0.10MF | 1.25MF | Airtightness | Joint strength | change ratio | Remarks |
| 4-1 | 6.5 | 2.9 | 0.46 | 5.75 | Pass | Excellent | 1.4 | Example |
| 4-2 | 5.7 | 2.9 | 0.41 | 5.13 | Pass | Excellent | 1.2 | Example |
| 4-3 | 5.8 | 2.9 | 0.38 | 4.75 | Pass | Excellent | 1.2 | Example |
| 4-4 | 5.5 | 2.9 | 0.35 | 4.38 | Pass | Excellent | 1.2 | Example |
| 4-5 | 5.2 | 2.9 | 0.34 | 4.25 | Pass | Excellent | 1.1 | Example |
| 4-6 | 5.0 | 2.9 | 0.34 | 4.25 | Pass | Excellent | 1.1 | Example |
| 4-7 | 4.8 | 2.9 | 0.32 | 4.00 | Pass | Excellent | 1.0 | Example |

As indicated in Table 5, the desired airtightness and joint strength was obtained for all Examples. In other words, stainless steel and copper joined bodies that had sufficient joint strength were obtained without cracking or joining discontinuities in the welded portion. Further, excellent airtightness and in particular, excellent joint strength were obtained for all Examples. Further, in Test No. 4-2 to 4-7, at least one of (f) to (h) was satisfied, and accordingly, widening of the bead width as welding progressed was suppressed, and stainless steel and copper joined bodies having excellent bead width stability, in particular, were obtained.

### INDUSTRIAL APPLICABILITY

The stainless steel and copper joined body according to an embodiment of the present disclosure is suitable for application to various products, including heat exchanger pipes or tubes, electronic device components, and household appliances.

1. A stainless steel and copper joined body, comprising stainless steel, copper, and a welded portion of the stainless steel and the copper, wherein
the stainless steel and the copper each have a sheet or tubular shape,
the welded portion is located at an overlapping portion where the stainless steel and the copper overlap each other, and the welded portion has a plurality of welding points that are continuous in the welding direction on the copper side surface of the joined body,
a Cu/Fe ratio of the welded portion is 10.0 or more,
MF and t satisfy the relationship in the following Expression (1),
MF and B satisfy the relationship in the following Expression (2),
$$MF \geq 0.8 t \qquad ( 1 )$$
$$0.1 MF \leq B \leq 1.25 MF \qquad ( 2 )$$
where
MF is distance, in mm, along the interface between the stainless steel and the copper of the joined body in the perpendicular-to-welding direction, between fusion boundaries between the welded portion and the copper,
B is average distance interval, in mm, of welding points on the copper side surface of the joined body, and
t is copper thickness, in mm.

2. The stainless steel and copper joined body according to claim 1, wherein Dₘₐₓ/Dₘᵢₙ satisfies the relationship in the following Expression (3),
$${D}_{max} / {D}_{min} \leq 1.4 \qquad ( 3 )$$
where
Dₘᵢₙ is minimum diameter, in mm, of the welding points on the copper side surface of the joined body, and
Dₘₐₓ is maximum diameter, in mm, of the welding points on the copper side surface of the joined body.

3. A method of joining stainless steel and copper, wherein overlapping stainless steel and copper material to be joined is joined by welding,
the welding is TIG welding,
the TIG welding comprises
positioning an electrode at the copper side of the material to be joined, and performing a plurality of heat inputs under conditions satisfying (a) to (e) below:
(a) inclination angle of electrode α is 0° to 45°,
where a thickness direction of the material to be joined is a reference angle, 0°, and the angle between the direction in which the tip of the electrode faces and the thickness direction of the material to be joined is the inclination angle of the electrode;
(b) electrode height is more than 0 mm and 3.0 mm or less;
(c) each heat input position in the perpendicular-to-welding direction, in mm, is 0.5×0.03×I×d^{0.5}/t^{0.5} or more and L−0.5×0.03×I×d^{0.5}/t^{0.5} or less,
where I is welding current in A, d is welding time in s, t is copper thickness in mm, and L is width of the overlapping portion where the stainless steel and the copper overlap each other, and further, each heat input position in the perpendicular-to-welding direction is set with a copper end of the overlapping portion as a reference position, 0, with the copper side as +ve and the stainless steel side as −ve;
(d) distance interval in the welding direction between each heat input point, in mm, is 0.1×{Dₖ₋₁×(1−0.2×t)} or more and Dₖ₋₁×(1−0.2×t) or less,
where Dₖ₋₁ is the diameter, in mm, of a welding point formed by the immediately preceding heat input on the copper side surface of the material to be joined, and t is the copper thickness, in mm; and
(e) time interval between each heat input is 100% or more of the welding time, in s, of the immediately preceding heat input,
and further, the relationship in the following Expression (4) is satisfied at each heat input,
$${t}^{1.5} / ( 1 - 0.2 \times t ) \div 0.03 \leq I \times {d}^{0.5} \leq {t}^{1.5} / ( 1 - 0.2 \times t ) \div 0.03 \times 6 \qquad ( 4 )$$
where
I is welding current in A,
d is welding time in s, and
t is copper thickness t, in mm.

4. The method of joining stainless steel and copper according to claim 3, wherein at least one of conditions (f) to (h) below are satisfied:
(f) for each heat input, the welding current of the heat input is the welding current of the immediately preceding heat input or less;
(g) for each heat input, the welding time of the heat input is the welding time of the immediately preceding heat input or less; or
(h) a long heat input time interval is provided between some heat inputs,
excluding a case where the welding current, the welding time, and the time interval between heat inputs are constant for each heat input.

5. A method of producing a stainless steel and copper joined body by joining stainless steel and copper by the method of joining stainless steel and copper according to claim 3.

6. A method of producing a stainless steel and copper joined body by joining stainless steel and copper by the method of joining stainless steel and copper according to claim 4.
